(19) United States
(12) Patent Application Publication
(10) Pub. No.: US 2016/0275089 A1
(43) Pub. Date: Sep. 22, 2016

(54) METHODS FOR IMPLEMENTING NOSQL DATABASE SNAPSHOTS AND DEVICES THEREOF

(71) Applicant: NetApp, Inc., Sunnyvale, CA (US)

(72) Inventors: Gokul Soundararajan, San Jose, CA (US); Jingxin Feng, San Jose, CA (US); Sethuraman Subbiah, San Jose, CA (US)

(21) Appl. No.: 14/660,817

(22) Filed: Mar. 17, 2015

(51) Int. Cl. G06F 17/30

(52) U.S. Cl. CPC G06F 17/30088; G06F 17/30182

(57) ABSTRACT

A method, non-transitory computer readable medium, and system node computing device that generates a snapshot identifier and returns the snapshot identifier in response to a received request to create a snapshot of a No SQL database. When an entry in a transaction table has a first transaction value corresponding to a transaction that has been committed and a second transaction value that is not assigned or corresponds to another transaction that has not been committed, is determined. The snapshot identifier is inserted into the entry when the entry is determined to have the first transaction value corresponding to the transaction that has been committed and the second transaction value that is not assigned or corresponds to the another transaction that has not been committed.

### FIELD

This technology generally relates to data storage systems and more particularly to methods and devices for implementing NoSQL database snapshots.

### BACKGROUND

Enterprises increasingly have a need to store large amounts of data in data storage systems to support modern applications. However, relational databases are not generally designed to effectively scale and often are not agile enough to meet current application requirements. Accordingly, enterprises are increasingly employing NoSQL (e.g., “No SQL” or “Not Only SQL”) databases to meet their data storage needs. NoSQL databases are able to store large volumes of data in a highly scalable infrastructure that is relatively fast and agile and generally provides superior performance over relational databases. Advantageously, NoSQL databases can be manipulated through object-oriented Application Programming Interfaces (APIs), offer relatively reliable code integration, and require fewer administrator resources to set up and manage as compared to relational databases.

However, current NoSQL databases are designed to be leveraged as solutions for relatively near term data storage. Accordingly, NoSQL databases do not provide data management features useful for relatively long term data storage, such as snapshots and aging or migration of data to different types of devices or media over time. In particular, current NoSQL databases do not provide effective tiering of ingested or stored data, such as in various types of media, devices, or infrastructure (e.g., flash, SSDs, HDDs, or cloud storage) that might satisfy various data management, data protection and availability, or data access policies established by application administrators.

Additionally, current NoSQL databases also do not provide effective snapshot capabilities that allow users to save and restore the state of the database a particular point in time, which is a desirable feature particularly for relatively long term data storage. More specifically, many NoSQL databases do not support transactions, and therefore cannot provide a consistent image of the database. Other NoSQL databases support snapshots in a storage-inefficient manner or with a significant and negative impact on database performance.

### SUMMARY

A method for implementing NoSQL database snapshots includes generating by a system node computing device a snapshot identifier and returns the snapshot identifier in response to a received request to create a snapshot of a NoSQL database. When an entry in a transaction table has a first transaction value corresponding to a transaction that has been committed, and a second transaction value that is not assigned or corresponds to another transaction that has not been committed, is determined by the system node computing device. The snapshot identifier is inserted, into the entry when the entry is determined to have the first transaction value corresponding to the transaction that has been committed and the second transaction value that is not assigned or corresponds to the another transaction that has not been committed. The determining and inserting steps are repeated by the system node computing device for each additional entry.

A non-transitory computer readable medium having stored thereon instructions for implementing NoSQL database snapshots comprising executable code which when executed by a processor, causes the processor to perform steps including generating a snapshot identifier and returns the snapshot identifier in response to a received request to create a snapshot of a NoSQL database. When an entry in a transaction table has a first transaction value corresponding to a transaction that has been committed, and a second transaction value that is not assigned or corresponds to another transaction that has not been committed, is determined. The snapshot identifier is inserted into the entry when the entry is determined to have the first transaction value corresponding to the transaction that has been committed and the second transaction value that is not assigned or corresponds to the another transaction that has not been committed. The determining and inserting steps are repeated for each additional entry.

A system node computing device including a processor and a memory coupled to the processor which is configured to be capable of executing programmed instructions comprising and stored in the memory to generate a snapshot identifier and returns the snapshot identifier in response to a received request to create a snapshot of a NoSQL database. When an entry in a transaction table has a first transaction value corresponding to a transaction that has been committed, and a second transaction value that is not assigned or corresponds to another transaction that has not been committed, is determined. The snapshot identifier is inserted into the entry when the entry is determined to have the first transaction value corresponding to the transaction that has been committed and the second transaction value that is not assigned or corresponds to the another transaction that has not been committed. The determining and inserting steps are repeated for each additional entry.

This technology provides a number of advantages including providing methods, non-transitory computer readable media, and devices that facilitate a NoSQL database with integrated management. With this technology, relatively fast, highly available, and application integrated NoSQL databases can be established in a data storage network such that various data management policies are automatically implemented. This technology also provides a highly scalable infrastructure that can add capacity dynamically and that optimizes the storage of data on types of media having different characteristics in order to provide cost-effective storage meeting end-user needs. Moreover, snapshot operations are provided with this technology that are lightweight and storage-efficient and that facilitate snapshot management even for large scale NoSQL databases storing a significant amount of data.

### BRIEF DESCRIPTION OF THE DRAWINGS

FIG. 1 a block diagram of a network environment with an exemplary data storage network with exemplary system node computing devices and storage node computing devices coupled to exemplary application server computing devices;

FIG. 2 is a block diagram of one of the exemplary application server computing devices;

FIG. 3 is a block diagram of one of the exemplary system node computing devices;

FIG. 4 is a block diagram of one of the exemplary storage node computing devices;

FIG. 5 is a flowchart of an exemplary method for facilitating by the one of the exemplary system node computing devices a NoSQL database with integrated management;

FIG. 6 is a table illustrating an exemplary portion of an exemplary REpresentational State Transfer (REST) Application Programming Interface (API) that can be used to perform system operations;

FIG. 7 is a table illustrating an exemplary portion of the exemplary REST API that can be used to perform database operations;

FIG. 8 is a table illustrating an exemplary portion of the exemplary REST API that can be used to perform table operations;

FIG. 9 is a table illustrating an exemplary portion of the exemplary REST API that can be used to perform entity group operations;

FIG. 10A is a table illustrating an exemplary portion of the exemplary REST API that can be used to perform a first set of item operations or transactions;

FIG. 10B is a table illustrating an exemplary portion of the exemplary REST API that can be used to perform a second set of item operations or transactions;

FIG. 11 is a functional flow diagram illustrating an exemplary method for retrieving an item previously stored in the exemplary data storage network;

FIG. 12 is a table illustrating an exemplary portion of the exemplary REST API that can be used to perform snapshot operations;

FIG. 13 is a flowchart of an exemplary method for processing transactions by the one of the exemplary system node computing devices;

FIG. 14 is a flowchart of an exemplary method for generating by the one of the exemplary system node computing devices a snapshot;

FIG. 15 is a flowchart of an exemplary method for restoring by the one of the exemplary system node computing devices a database from a snapshot; and

FIG. 16 is a flowchart of an exemplary method for implementing by the one of the exemplary system node computing devices a system cleanup to recycle unnecessary portions of the transaction table used to manage snapshots.

### DETAILED DESCRIPTION

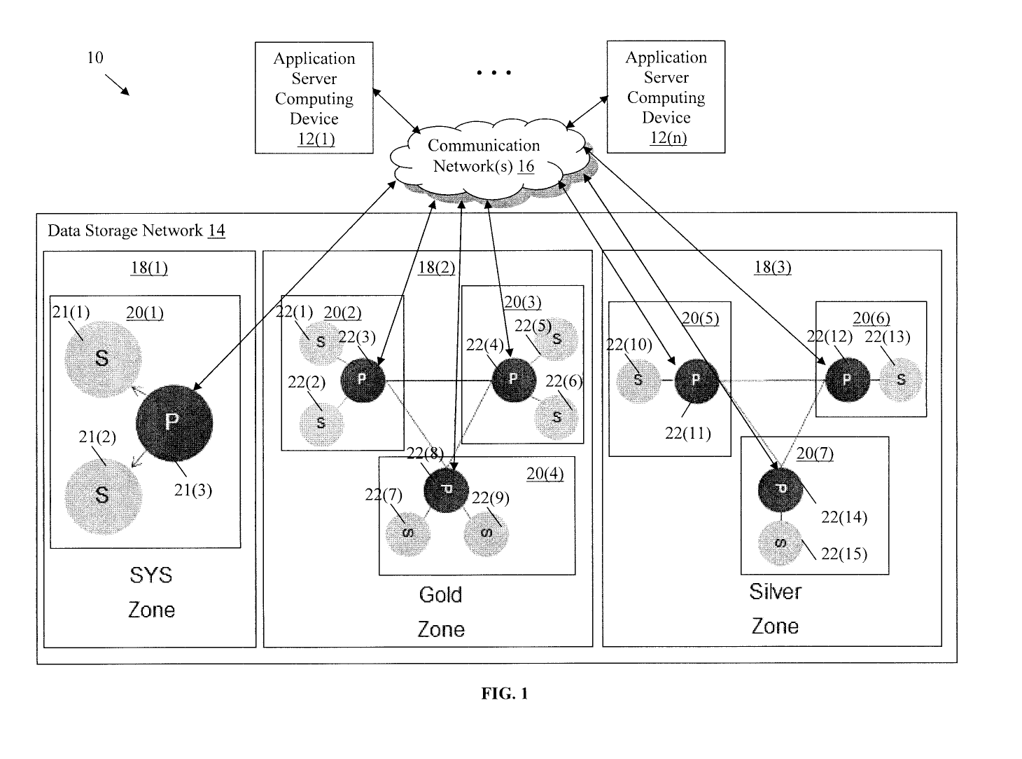

A network environment 10 including exemplary application server computing devices 12(1)-12(n) that access and utilize a data storage network 14 via communication network(s) 16 is illustrated in FIG. 1. In this particular example, the data storage network 14 is organized into three zones 18(1)-18(3), which include groups 20(1), 20(2)-20(4), and 20(5)-20(7), respectively. Also in this example, the group 20(1) includes system node computing devices 21(1)-21(3) and the groups 20(2)-20(4) and 20(5)-20(7) include storage node computing devices 22(1)-22(9), and 22(10)-22(15), respectively. In other examples, the data storage network 14 can include any number of zones including any number of groups that include any number of storage node computing devices, and the network environment 10 can include other numbers and types of systems, devices, components, and/or elements in other configurations.

Each of the groups 20(2)-20(4) and 20(5)-20(7) in each respective zone 18(2) and 18(3) in this example have the same topology satisfying one or more service level capabilities (SLCs) and zone 18(1) is a system zone storing metadata for the data storage network 14, as described and illustrated in more detail later. This technology provides a number of advantages including methods, non-transitory computer readable media, and devices that facilitate a NoSQL database with integrated data management and more effectively manage stored data to satisfy SLCs required by application administrators.

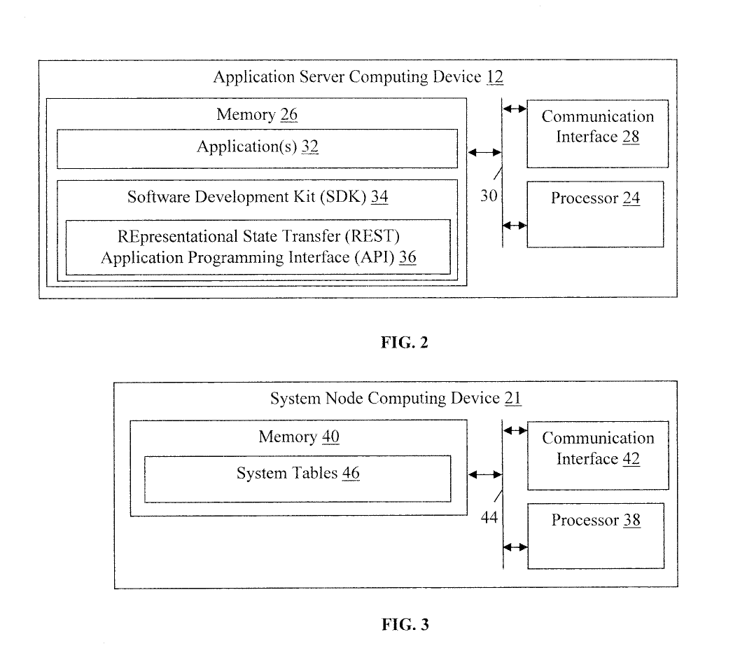

Referring to FIG. 2, a block diagram of one of the exemplary application server computing devices 12(1)-12(n) is illustrated. The application server computing device 12 in this example hosts application(s) that can be accessed by users of client devices (not shown), such as over the Internet for example, and that utilize the data storage network 14 via the communication network(s) 16 to store associated data. The data storage network 14 facilitates storage and retrieval by the hosted application(s) of a large amount of data for a relatively long term, and in a highly available and scalable infrastructure that can be efficiently managed according to the requirements and policies defined by application administrator(s), as described and illustrated in more detail later.

The application server computing device 12 in this example includes a processor 24, a memory 26, and a communication interface 28, which are all coupled together by a bus 30 or other communication link, although the application server computing device 12 can have other types and numbers of components or other elements. The processor 24 of the application server computing device 12 executes a program of stored instructions for one or more aspects of this technology, as described and illustrated by way of the embodiments herein, although the processor 24 could execute other numbers and types of programmed instructions. The processor 24 in the application server computing device 12 may include one or more central processing units or general purpose processors with one or more processing cores, for example.

The memory 26 of the application server computing device 12 may include any of various forms of read only memory (ROM), random access memory (RAM), Flash memory, non-volatile, or volatile memory, or the like, or a combination of such devices for example. In this particular example, the memory 26 further includes hosted application(s) 32 and a software development kit (SDK) 34 that includes a REpresentational State Transfer (REST) Application Programming Interface (API) 36.

The application(s) 32 generally require large scale data storage over a relatively long period of time in this example. The SDK 34 defines functionality for establishing, interacting with, and managing a NoSQL database hosted by the data storage network 14. The SDK 34 can leverage the REST API 36 to make calls to one or more of the system node computing devices 21(1)-21(3) or storage node computing devices 22(1)-22(15) by mapping operations in the HTTP protocol, as described and illustrated in more detail later. In other examples, the application server computing device 12 can invoke operations and submit transactions by calling the REST API 36 (over HTTP) directly. While in this example the SDK 34 is co-located on the application server computing device 12 with the application(s) 32, in other examples, the data storage network 16 can include a front-end server computing device (not shown) that encapsulates the logic of the SDK 34, and other implementations of and locations for the SDK 34 logic can also be used.

The communication interface 30 of the application server computing device 12 operatively couples and communicates over communication network(s) 16 between the application server computing device 12 and at least those system and storage node computing devices 21(3), 22(6), 22(7), 22(11), 22(14), 22(15), and 22(17) designated as primary storage nodes in this example, although other types and numbers of communication networks or systems with other types and numbers of connections and configurations to other devices and elements can also be used. By way of example only, the communication network(s) 16 can use TCP/IP over Ethernet, although other types and numbers of communication networks can be used. The communication network(s) 16 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), or combinations thereof.

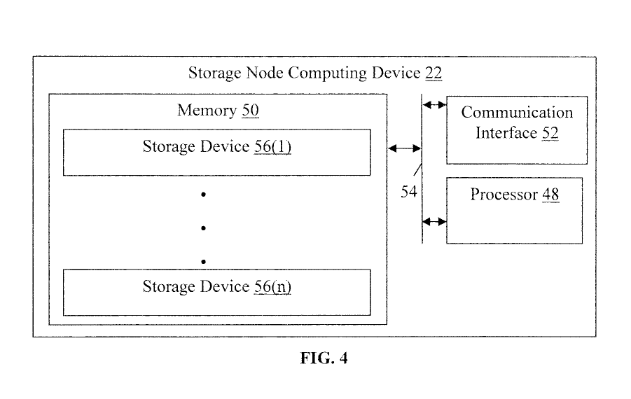

Referring more specifically to FIG. 3, a block diagram of one of the exemplary system node computing devices is illustrated. In this particular example, all of the system node computing devices 21(1)-21(3) are the same in structure and operation as the exemplary system node computing device shown in FIG. 3 except as otherwise illustrated or described herein, although one or more of the system node computing devices 21(1)-21(3) could have other types and/or numbers of other systems, devices, components and/or other elements in other configurations. The system node computing devices 21(1)-21(3) are generally configured to store metadata for the data storage network 14. Accordingly, the system node computing device2 21(1)-21(3) are the first point of contact in the data storage network 14 for the application server computing devices 12(1)-12(n) that are performing transactions with respect to items stored by the data storage network 14, as described and illustrated in more detail later. The system node computing devices 21(1)-21(3) can be physical or virtual, located in the same or different location, and designated as primary secondary nodes.

In this particular example, the system node computing device 21 includes a processor 38, a memory 40, and a communication interface 42, which are all coupled together by a bus 44 or other communication link, although the system node computing device 21 can have other types and numbers of components or other elements. The processor 38 of the system node computing device 21 executes a program of stored instructions for one or more aspects of this technology, as described and illustrated by way of the embodiments herein, although the processor 38 could execute other numbers and types of programmed instructions. The processor 38 may include one or more central processing units or general purpose processors with one or more processing cores, for example.

The memory 40 of the system node computing device 21 may include any of various forms of read only memory (ROM), random access memory (RAM), Flash memory, non-volatile, or volatile memory, or the like, or a combination of such devices for example. In this example, the memory 40 further includes system tables 46 that store metadata for the data storage network 14 including information regarding the nodes, groups, zones, databases, tables, and transactions, for example, as described and illustrated in more detail later.

The communication interface 42 of the system node computing device 21 in this example operatively couples and communicates between the system node computing device 21 and an associated primary system node, when the system node computing device 21 is designated as a secondary system node, or the application server computing devices 12(1)-12(n), when the system node computing device 21 is designated as a primary system node, via the communication network(s) 16, although other types and numbers of communication networks or systems with other types and numbers of connections and configurations to other devices and elements can also be used.

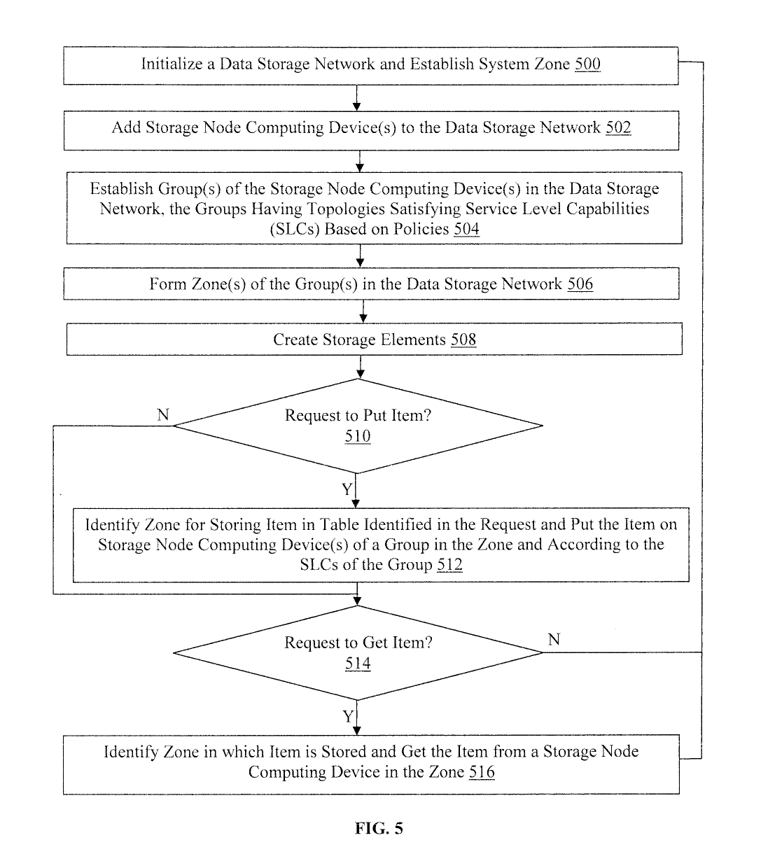

Referring more specifically to FIG. 4, a block diagram of one of the exemplary storage node computing devices 22(1)-22(15) is illustrated. In this particular example, all of the storage node computing devices 22(1)-22(15) are the same in structure and operation as the one of the exemplary storage node computing devices 22(1)-22(15) shown in FIG. 4 except as otherwise illustrated or described herein, although one or more of the storage node computing devices could have other types and/or numbers of other systems, devices, components and/or other elements in other configurations. The storage node computing devices 22(1)-22(15) are generally configured to receive requests to get and put items from the application server computing devices 12(1)-12(n) over the communication network(s) 16. The storage node computing devices 22(1)-22(15) can be virtual storage nodes implemented on virtual machines executing on host device(s) or physical storage nodes. Additionally, one or more of the storage node computing devices 22(1)-22(15) can be located in the same data center or in different data centers (e.g., in different geographic locations or in a cloud storage network).

The storage node computing devices 22(1)-22(15) can be designated as primary or secondary, as described and illustrated in more detail later, and have associated roles and responsibilities with respect to the associated ones of the groups 20(2)-20(7) based on the designation, also as described and illustrated in more detail later. However, the storage node computing devices 22(1)-22(15) that are in the same one of the groups 20(2)-20(7) satisfy the same set of SLCs associated with the corresponding one of the groups 20(2)-20(7) and the associated one of the zones 18(1)-18(3), also as described and illustrated in more detail later.

In this particular example, the storage node computing device 22 includes a processor 38, a memory 50, and a communication interface 52, which are all coupled together by a bus 54 or other communication link, although the storage node computing device 22 can have other types and numbers of components or other elements. The processor 48 of the storage node computing device 22 executes a program of stored instructions for one or more aspects of this technology, as described and illustrated by way of the embodiments herein, although the processor 48 could execute other numbers and types of programmed instructions. The processor 48 may include one or more central processing units or general purpose processors with one or more processing cores, for example.

The memory 50 of the storage node computing device 22 may include any of various forms of read only memory (ROM), random access memory (RAM), Flash memory, non-volatile, or volatile memory, or the like, or a combination of such devices for example. In this example, the memory 50 further includes storage devices 56(1)-56(n). The storage device(s) 56(1)-56(n) can include optical disk-based storage, solid state drives, tape drives, flash-based storage, other types of hard disk drives, or any other type of storage devices suitable for storing items for short or long term retention, for example. Other types and numbers of storage devices can be included in the memory 50 or coupled to the storage node computing device 22 in other examples.

The communication interface 52 of the storage node computing device 22 in this example operatively couples and communicates between the storage node computing device 22 and an associated primary storage node, when the storage node computing device 22 is designated as a secondary storage node, or the application server computing devices 12(1)-12(n), when the storage node computing device 22 is designated as a primary storage node, via the communication network(s) 16, although other types and numbers of communication networks or systems with other types and numbers of connections and configurations to other devices and elements can also be used.

Although examples of the application server computing devices 12(1)-12(n), system node computing devices 21(1)-21(3), and storage node computing devices 22(1)-22(15) are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples also may be embodied as one or more non-transitory computer readable media having instructions stored thereon for one or more aspects of the present technology, as described and illustrated by way of the examples herein, which when executed by a processor, cause the processor to carry out the steps necessary to implement the methods of this technology, as described and illustrated with the examples herein.

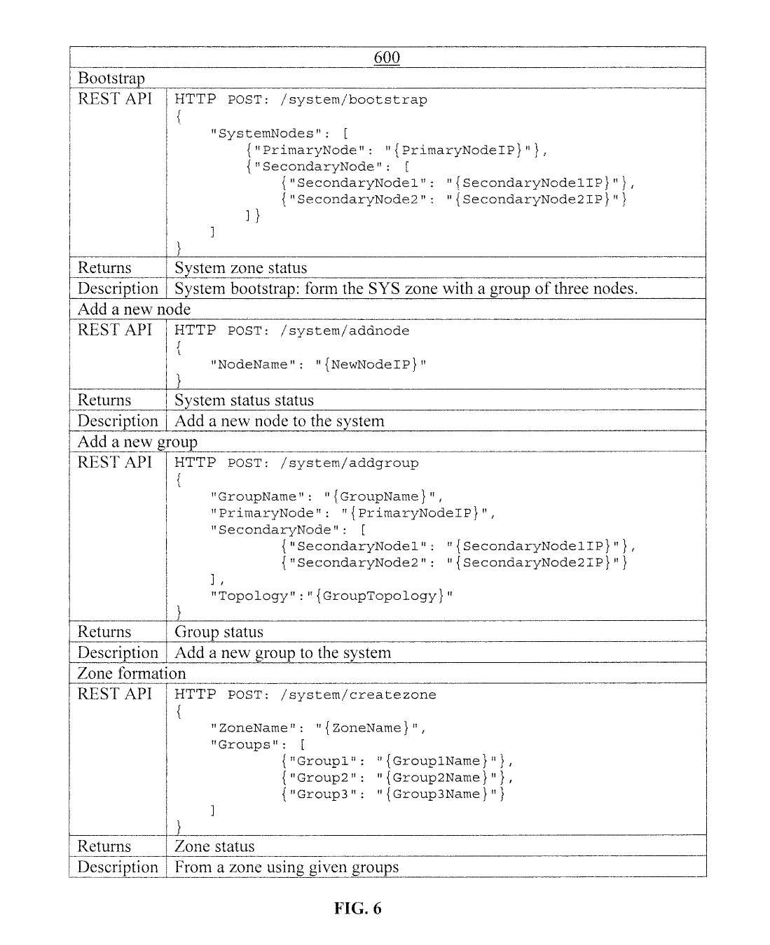

An exemplary method for facilitating a NoSQL database with integrated management will now be described with reference to FIGS. 1-12. Referring more specifically to FIG. 5, in step 500 in this particular example, the data storage network 14 is initialized and the system zone 18(1) is established. In order to initialize the data storage network 14, the one of the application server computing devices 12(1)-12(n) or an administrator using an administrator computing device (not shown) coupled to the communication network(s) 16 communicates optionally using the SDK 34 to generate a bootstrap request based on the REST API 36.

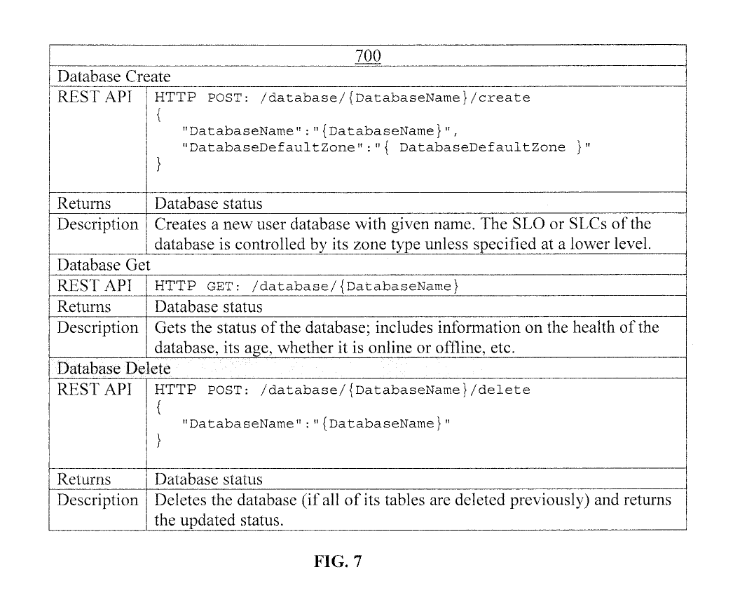

Referring more specifically to FIG. 6, a table 600 including an exemplary portion of the REST API 36 that can be used by the one of the application server computing devices 12(1)-12(n) or an administrator computing device to perform system operations is illustrated. In this example, the bootstrap request is generated using the REST API 36 to form the system zone 18(1) with a group 20(1) of three system node computing devices 21(1)-21(3), which are identified in the bootstrap request by their Internet Protocol (IP) addresses, although the system zone 18(1) can be formed using any number of system node computing devices.

Additionally, in this example, the system node computing device 21(3) is designated in the bootstrap request as a primary storage node computing device for the group 18(1), and the system node computing devices 21(2) and 21(3) are designated in the bootstrap request as secondary system node computing devices for the group 18(1). Accordingly, all system operations and other transactions requested by the one of the application server computing devices 12(1)-12(n) or an administrator computing device will be initially handled by the primary system node computing device 21(3), which will then decide whether to access the secondary system node computing devices 21(2) and 21(3) in order to service the request (e.g., for capacity, scalability, or redundancy/data protection purposes, although other reasons for utilizing the secondary system node computing devices 21(2) and 21(3) can also be used) or to instruct the requesting computing device to access one of the primary storage node computing devices 22(3), 22(4), 22(8), 22(11), 22(12), or 22(14) of another one of the zones 18(2) or 18(3).

In this example, the system node computing devices 21(1)-21(3) of the system zone 18(1) stores system tables including a nodes table, a groups table, a zones table, a databases table, and a tables table. The nodes table includes a row with a unique identifier, an IP address, and a physical location for each storage node computing device 22(1)-22(15) in the data storage network 14. The groups table describes each group 20(1)-20(7) formed, as described and illustrated in more detail later with reference to step 404 of FIG. 4, and includes a unique group identifier and an indication of the set of the system and storage node computing devices 21(1)-21(3) and 22(1)-22(15) included in each of the groups 20(1)-20(7). The zones table includes a row for each of the zones 18(1)-18(3) including a unique zone identifier and a link to an optional master one of the system and storage node computing devices 21(1)-21(3) and 22(1)-22(15) for the zone 18(1)-18(3).

The databases table in this example includes a row for each database created as described and illustrated in more detail later with reference to step 408 of FIG. 4. The databases table includes a unique database identifier, a user (e.g., administrator) identifier, and a database status. Additionally, the tables table includes a row for each table created as described and illustrated in more detail later with reference to step 508 of FIG. 5. The tables table includes a corresponding one of the unique database identifiers, a user (e.g., administrator) identifier, and a table status for each table created as described and illustrated in more detail later with reference to step 508 of FIG. 5. In other examples other types and numbers of system tables can also be stored in the system zone 18(1). Accordingly, a bootstrap request initiated by the one of the application server computing device 12(1)-12(n) or an administrator computing device causes the identified primary system node computing device 21(3) to establish the set of system tables, which are populated as described and illustrated in more detail later.

Referring back to FIG. 5, in step 502, the system node computing device 21(3) adds the storage node computing devices 22(1)-22(15) to the data storage network 14 that was bootstrapped in step 500, although other numbers of storage node computing devices can be added in other data storage networks in other examples. The system node computing device 21(3) adds the storage node computing devices 22(1)-22(15) in response to an add new node request received from the one of the application server computing devices 12(1)-12(n) or an administrator computing device, as optionally generated using the SDK 34 and based on the REST API 36, for each of the storage node computing devices 22(1)-22(15).

Referring back to FIG. 6 and the table 600, the add new node requests in this example each include the IP address of one of the storage node computing devices 22(1)-22(15) and are sent to the primary system node computing device 21(3) of the system zone 18(1). In response, the system node computing device 21(3) updates the nodes ones of the system tables 46 to include the information described and illustrated earlier regarding the added storage node computing devices 22(1)-22(15).

In step 504, the system node computing device 21(3) establishes the groups 20(2)-20(7) of storage node computing devices 22(1)-22(15), although other numbers of groups can be added in other data storage networks in other examples. The system node computing device 21(3) establishes the groups 20(2)-20(7) of storage node computing devices 22(1)-22(15) in response to an add group request received from the one of the application server computing devices 12(1)-12(n) or an administrator computing device, as optionally generated using the SDK 34 and based on the REST API 36, for each of the groups 20(2)-20(7).

Referring back to FIG. 6 and the table 600, the add new group requests in this example each include the IP address and a designation of “primary” or “secondary” for each of the set of the storage node computing devices 22(1)-22(15) to be included in each of the groups 20(2)-20(7). Additionally, each add group request includes an indication of a unique group name and a group topology indication (e.g., gold or silver). The add group requests are sent to the primary storage node computing device 21(3) of the system zone 18(1), which updates the groups table to include the information described and illustrated earlier regarding the established groups 20(2)-20(7).

The group topology indication (e.g., gold or silver) identifies a topology that satisfies a set of SLCs. The SLCs correspond with established data placement policies, data protection policies, and/or data access policies for the data storage network 14. Additionally, the SLCs determine a performance, cost, data protection scheme, or transaction consistency, for example, implemented by the storage node computing devices 22(1)-22(15) in respective ones of the groups 20(2)-20(7) that share the same topology.

For example, a data placement policy may specify the location of data storage and can be defined by a service-level objective (SLO) that dictates the performance and cost of the data storage. Accordingly, a data placement policy can be specified at the database level, table level, or entity-group level based on an indication of the associated zone upon creation of the database, table, or entity-group, as described and illustrated in more detail later with reference to step 508 of FIG. 5. In one example, a data placement policy may specify that the read-ops of a table should be 500 and the cost-per-gb should be 10 cents or less, which are provided by the storage node computing devices 22(1)-22(9) of the groups 20(2)-20(4) of the gold zone 18(2). Data placement policies can be implemented in many ways by the zones 18(2) and 18(3), such as by storing data on certain types of media or in certain locations (e.g., in the data center or on a cloud storage network).

Data protection and availability policies can be specified at the database, table, snapshot, or entity-group level. In one example, a data protection policy may specify the annual-failure-rate (AFR) of 1% and a recovery-time-objective of 1 hour, which are provided by the storage node computing devices 22(10)-22(15) of the groups 20(5)-20(7) of the silver zone 18(3) implementing data replication, dynamic disk pooling, or erasure coding, for example, across the groups 20(5)-20(7).

Additionally, data access policies can be specified at the transaction level. In one example, one of the application(s) 32 issues operations on items (e.g., create-item, update-item, delete-item, or query-items) to one or more created tables, as described and illustrated in more detail later with reference to steps 510-516 of FIG. 5. The operations are encapsulated in a transaction that in this example provides atomicity, consistency, isolation, and durability (ACID) properties. In some examples, a transaction can be strongly-consistent (e.g., appearing as if executed serially) or eventually-consistent, such that changes made by concurrent transactions may be seen before a transaction commits. Accordingly, strongly-consistent or eventually-consistent transaction processing can be provided in some examples by the storage node computing devices 22(1)-22(9) or 22(10)-22(15) of the gold zone 18(2) or silver zone 18(3), respectively.

In step 506, the system node computing devices 21(3) forms zones 18(2) and 18(3) of the groups 20(2)-20(4) and 20(5)-20(7), established as described and illustrated earlier with reference to step 504 of FIG. 5. the system node computing devices 21(3) forms zones 18(2) and 18(3) of the groups 20(2)-20(4) and 20(5)-20(7) in response to an add zones request received from the one of the application server computing devices 12(1)-12(n) or an administrator computing device, optionally generated using the SDK 34 and based on the REST API 36, for each set of the groups 20(2)-20(4) and 20(5)-20(7).

Referring back to FIG. 6 and the table 600, the add new zone requests in this example include the unique group names for each of groups 20(2)-20(4) and 20(5)-20(7). Additionally, each add zone request includes an indication of a unique zone name, which optionally corresponds with the group topology indication (e.g., gold or silver) of the groups that are to be included in the zone being formed. The add zone requests are received by the primary storage node computing device 21(3) of the system zone 18(1), which updates the zones table to include the information regarding the formed zones 20(2)-20(7).

In the exemplary data storage network 14, the basic functionality of the storage node computing devices 22(1)-22(15) is the same, but the storage node computing devices 22(1)-22(3), 22(4)-22(6), 22(7)-22(9), 22(10)-22(11), 22(12)-22(13), and 22(14)-22(15) are organized into groups 20(2), 20(3), 20(4), 20(5), 20(6), and 20(7), respectively. The groups 20(2)-20(4) and 20(5)-20(7) are then organized into zones 18(2) and 18(3), respectively, for easier management and hardware additions and removals, among other advantages.

The topology of the groups 20(2)-20(4) and 20(5)-20(7) of the zones 18(2) and 18(3), respectively, is determined by the set of SLCs that the groups 20(2)-20(4) and 20(5)-20(7) provide. Accordingly, zones 18(2) and 18(3) consist of groups 20(2)-20(4) and 20(5)-20(7), respectively, implementing the same topology. Since the groups 20(2)-20(4) and 20(5)-20(7) implement the same respective topology, they deliver the same performance. Accordingly, adding a new group to a zone increases the available capacity of a zone and thereby provides a highly scalable infrastructure with reliable performance.

In this particular example, the zone 18(2) is a gold zone and the zone 18(3) is a silver zone, although any number of zones having another identifier and/or associated set of SLCs or level of service can also be used in other data storage networks. Accordingly, the groups 20(2)-20(4) of the gold zone 18(2) each provide a gold level service (e.g., read-ops of 500, average latency of 2 ms, and a recovery-point-objective of 30 minutes). In this example, the gold level service is implemented by a set of three storage node computing devices 22(1)-22(3), 22(4)-22(6), and 22(7)-22(9) in which stored data is replicated across three Flash-based disk storage devices.

In another example, the groups 20(5)-20(7) of the silver zone 18(3) provide a silver level service that is implemented with a set of two storage node computing devices 22(10) and 22(11), 22(12) and 22(13), and 22(14) and 22(15) using local RAID on HDD storage devices. The topologies of the groups 20(2)-20(4) and 20(5)-20(7) can be established and provided by manufacturers of the storage node computing devices 22(1)-22(15) or defined by an administrator of the data storage network 14, for example.

In step 508, the system node computing device 21(3) creates a plurality of storage elements including at least a NoSQL database, an entity group associated with the database, and a table associated with the entity group. The system node computing device 21(3) creates the storage elements in response to requests to create the storage elements received from the one of the application server computing devices 12(1)-12(n) or an administrator computing device, as optionally generated using the SDK 34 based on the REST API 36. In this example, at least one of the requests to add one of the storage elements includes an indication of a zone name, which is used to store associated items in one of the zones 18(2) or 18(3), as described and illustrated in more detail later.

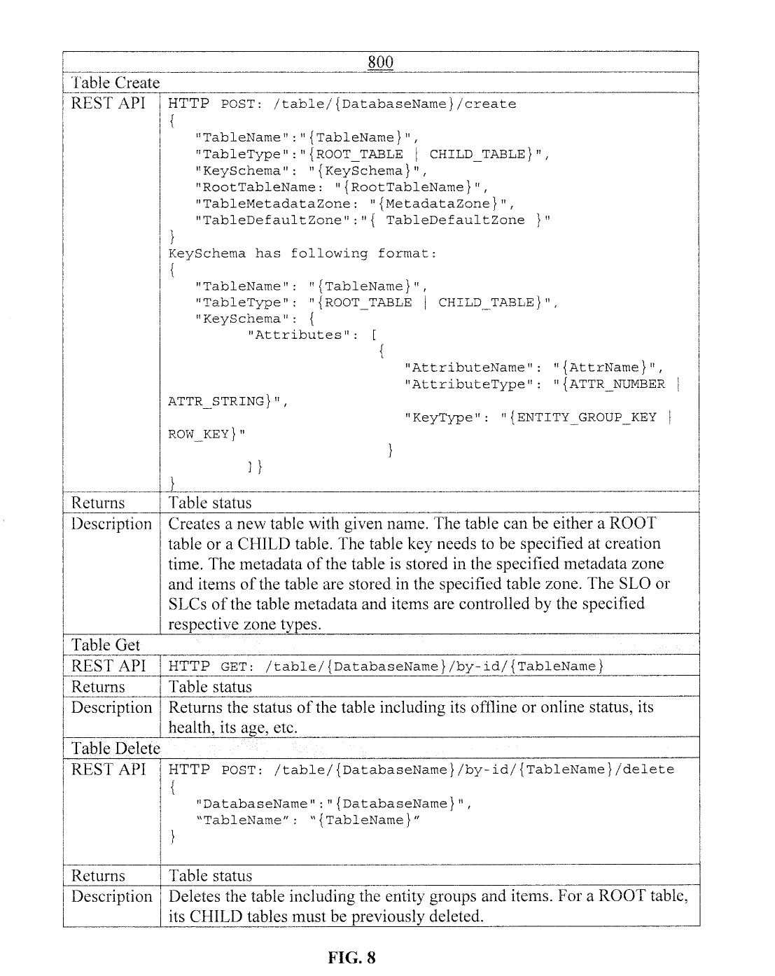

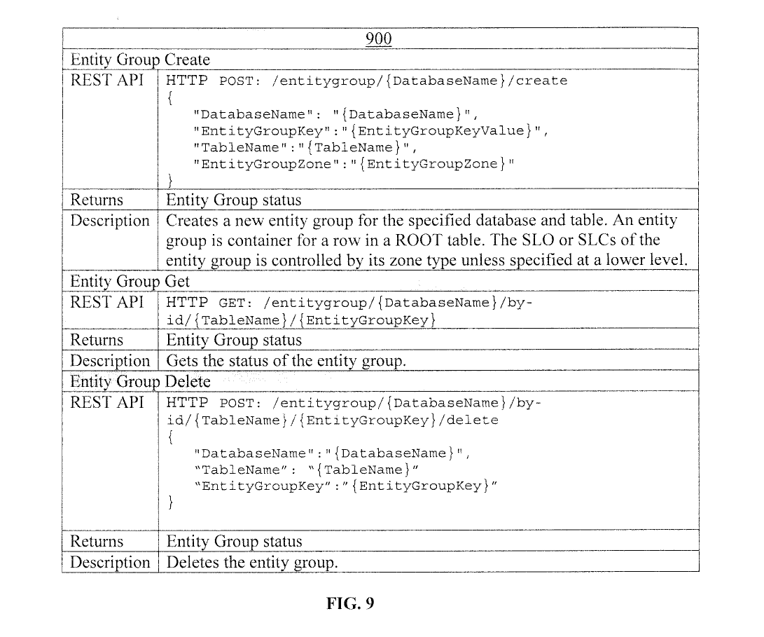

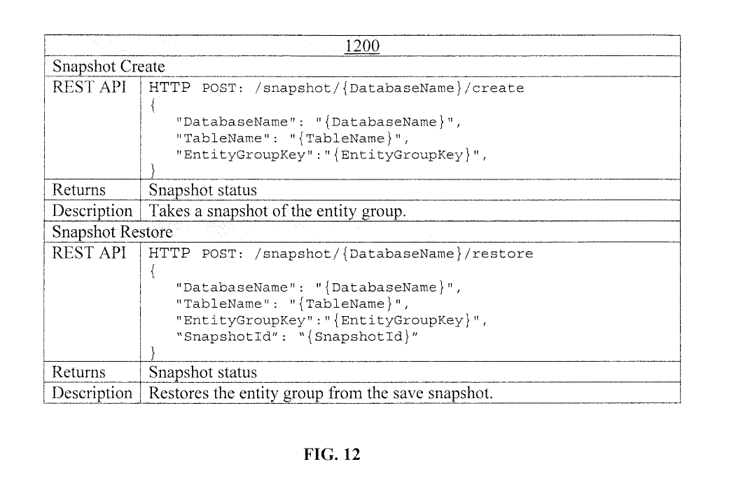

In this example, the data model used in the data storage network 14 consists of databases, tables, entity-groups, items, and attributes. At the highest level, an administrator of one of the application(s) 32 hosted by the one of the application server computing device 12(1)-12(n) creates a database as described and illustrated in more detail later with reference to FIG. 7. In this example, the database consists of one or more tables that can also be created as described and illustrated in more detail later with reference to FIG. 8. A table consists of items that include a collection of attributes. The application(s) 32 can issue operations on items or commands (e.g., insert-item, update-item, delete-item, or read-item(s)) to one or more tables. The operations are encapsulated as transactions that are sent to the system node computing device 21(3) in this example. A snapshot or point-in-time version of a table/entity-group can also be taken, as described and illustrated in more detail later with reference to FIGS. 12 and 14-15.

Also in this particular example, an item is represented using a JavaScript Object Notation (JSON) format consisting of a collection of attribute key/value pairs where the key is a string and the values may be strings, numbers, or other JSON objects, although other types of item formats can be used in other examples including XML or any other custom format. For example, an item representing a person is shown below in JSON format:

{

“SSN”: “555-55-5555”,
“Firstname”:”John”,
“Lastname”:”Smith”,
“Age”:50,
“Email”:”john.smith@domain.com”

}

The “SSN”: “555-55-5555” in the above example represents an attribute, where “SSN” is the key and “555-55-5555” represents the value. The above example consists of five attributes. Of these, one of the item's attributes is designated as its primary key or attribute that uniquely identifies the item, which can be the “SSN” in the above example.

A table stores a collection of items and can be a ROOT table or a CHILD table. An item in a ROOT table is an entity-group, and therefore the primary key of an item in the ROOT table is an entity-group key. A CHILD table is a sub-table of a ROOT table such that items in a CHILD table need to be referenced using both an entity-group key and the child item's primary key. For example, a ROOT table “Persons” and a CHILD table “Addresses” can be created, as described and illustrated in more detail later with reference to FIG. 8, wherein the address is uniquely tied to a person. Accordingly, referring to the above example, an exemplary item in the “Addresses” table is shown below in the JSON format:

{

“SSN”: “555-55-5555”,
“Id”: “Home”,
“Street”: “50 Main Street”,
“City”: “Busytown”,
“State”: “CA”,
“ZipCode”: “55555”

}

In this example, a person's address (John's address in the above example), is identified by using the entity-group key (“SSN”: “555-55-5555”) and the address id (“Id”: “Home”), which is the primary key for the address item.

Additionally, in this particular example, an entity-group is an item in the ROOT table. The entity-group defines a logical group of items and defines the interface between logical and physical data grouping. Accordingly, items in CHILD tables referenced by the same entity-group key are considered to be part of the same entity-group in this example. All operations within an entity-group can be executed atomically and can provide strongly-consistent guarantees or, alternatively, strongly-consistent guarantees can be provided for transactions that span entity-groups using an underlying algorithm such as 2PC as disclosed in Bernstein et al., “Concurrency Control and Recovery in Database Systems,” 1987, for example, which is incorporated by reference herein in its entirety or Paxos as disclosed in Lamport, “The Part-Time Parliament”, ACM Transactions on Computer Systems 16, 2, May, 1998, p. 133-169, for example, which is incorporated by reference herein in its entirety, although other algorithms for guaranteeing strong consistency for transactions can also be used.

Referring more specifically to FIG. 7, a table 700 including an exemplary portion of the REST API 36 that can be used to perform database operations is illustrated. In this example, the operations include database-create, database-get, and database-delete, although other operations can also be used in other examples. Accordingly, a NoSQL database can be created in step 508 of FIG. 5 via a request generated by the one of the application server computing devices 12(1)-12(n) that includes a database name and specifies an optional database zone. The request is received by the primary system node computing device 21(3) of the system zone 18(1), which updates the databases one of the system tables 46 to include information regarding the created database.

Optionally, the specified database zone (the “{DatabaseDefaultZone}” in this example) can correspond with the zone name used in the request to form the zone (e.g., “gold” or “silver” for the exemplary zones 18(2) and 18(3), respectively), as stored in the zones one of the system tables 46 by the system zone 18(1), as described and illustrated in more detail earlier with reference to step 506 of FIG. 5. In examples in which the database zone is specified in the request to create the database, items stored in tables associated with the database will be stored on one or more of the storage node computing devices 22(1)-22(15) in the specified zone, unless a different zone is specified in the request to create the entity group(s) associated with the tables, or in the request to create the tables. Accordingly, in this example zones are inherited from top level (e.g., database) to bottom level (e.g., table) and can be overridden, although other hierarchies can also be used in other examples.

Referring more specifically to FIG. 8 a table 800 including an exemplary portion of the REST API 36 that can be used to perform table operations is illustrated. In this example, the operations include table-create, table-get, and table-delete, although other operations can also be used in other examples. Accordingly, a table can be created in step 508 of FIG. 5 via a request generated by the one of the application server computing devices 12(1)-12(n) or an administrator computing device that includes a table name, table type, key schema, and root table name, and that specifies a table metadata zone and an optional table default zone. The request is received by the primary system node computing device 21(3) of the system zone 18(1), which updates the tables of the system tables 46 to include information regarding the created table.

Optionally, the specified table zone (the “{TableDefaultZone}” in this example) can correspond with the zone name used in the request to form the zone, as stored in the zones table by the system zone 18(1), as described and illustrated in more detail earlier with reference to step 506 of FIG. 5. In examples in which the table zone is specified in the request to create the table, items stored in the table will be stored on one or more of the storage node computing devices 22(1)-22(15) in the specified zone. In examples in which the optional table zone is not specified, the zone can be inherited from the associated entity group or database, as specified in the respective request to create the associated entity group or database, as described and illustrated in more detail earlier.

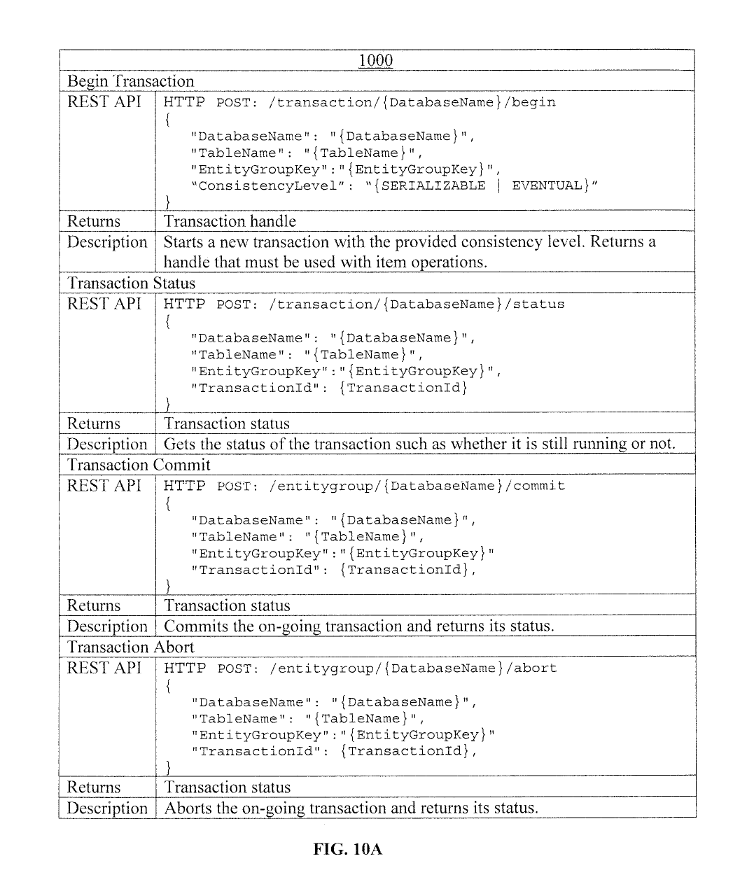

Referring more specifically to FIG. 9 a table 900 including an exemplary portion of the REST API 36 that can be used to perform entity group operations is illustrated. In this example, the operations include entity-group-create, entity-group-get, and entity-group-delete, although other operations can also be used in other examples. Accordingly, an entity group can be created in step 508 of FIG. 5 via a request generated by the one of the application server computing devices 12(1)-12(n) or an administrator computing device that includes a database name, an entity group key, and a table name, and optionally specifies an entity group zone. The request is received by the primary system node computing device 21(3) of the system zone 18(3), which optionally stores information regarding the created entity group.

Optionally, the specified entity group zone (the “{EntityGroupZone}” in this example) can correspond with the zone name used in the request to form the zone, as stored in the zones table by the system zone 18(1), as described and illustrated in more detail earlier with reference to step 506 of FIG. 5. In examples in which the entity group zone is specified in the request to create the entity group, items stored in tables associated with the entity group will be stored on one or more of the storage node computing devices 22(1)-22(15) in the specified zone, unless one or more of the tables associated with the entity group were associated with a zone upon creation, as described and illustrate earlier. In examples in which the optional entity group zone is not specified, the zone can be inherited from the associated database, as specified in the request to create the associated database, or the zone in which items are stored can be specified at the table level in the request to create tables associated with the entity group, as described and illustrate earlier.

Referring back to FIG. 5, two exemplary item operations, including item-put and item-get operations, will now be described with reference to steps 510-516, although other item operations can also be used in other examples. Accordingly, in step 510, system node computing device 21(3) determines whether a request has been received from one of the application(s) 32 executing on one of the application server computing devices 12(1)-12(n), optionally using the SDK 34 and via the REST API, to put an item in a database, such as the database created in step 508. If the system node computing device 21(3) determines that a request to put an item has been received, then the Yes branch is taken to step 512.

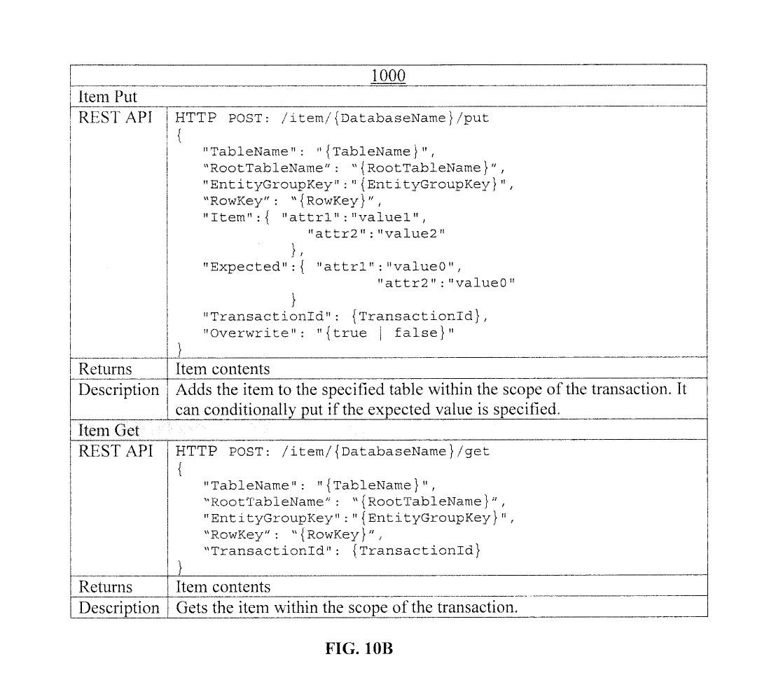

In step 512, the system node computing device 21(3) determines where the item is to be stored based on contents of the system tables 46. Referring more specifically to FIGS. 10A-10B a table 1000 including an exemplary portion of the REST API 36 that can be used to perform item operations or transactions is illustrated. In this example, the item-put operation request includes a table name, root table name, entity group key, row key, item and associated attribute key/value pairs, expected attribute key/value pairs, a transaction identifier, and an overwrite indication.

Accordingly, the item-put transaction received by the system node computing device 21(3) includes an indication of the table (e.g., “{TableName}”), which is used by the system node computing device 21(3) to identify a specified one of the zones 18(2) or 18(3) for the table in which the item is to be put. In one example, the system node computing device 21(3) determines from the tables one of the system tables 46 that the metadata for the table is stored in the gold zone 18(2), which is communicated back to the one of the application server computing devices 12(1)-12(n). The tables one of the system tables 46 could have been previously populated based on the “TableMetadataZone” indicating the gold zone 18(2) in the table-create request received by the system node computing device 21(3), as described and illustrated earlier with reference to step 508 of FIG. 5.

In response, the one of the application server computing devices 12(1)-12(n) can communicate with one of the primary storage node computing devices 22(3), 22(4), or 22(8) of the gold zone 18(2). The one of the primary storage node computing devices 22(3), 22(4), or 22(8) of the gold zone 18(2) may determine that the table data (e.g., the items) is stored in the silver zone 18(3), which is communicated back to the one of the application server computing devices 12(1)-12(n). In response, the one of the application server computing devices 12(1)-12(n) can communicate with one of the primary storage node computing devices 22(11), 22(12), or 22(14) of the silver zone 18(3) in order to store the item specified in the original item-put operation request. Accordingly, the gold zone 18(2) in this example stored the metadata for the table including an indication that items stored in the table are located in the silver zone 18(2), which could have been explicitly established the table-create request or inherited from an entity group or database associated with the table in which the item is to be stored.

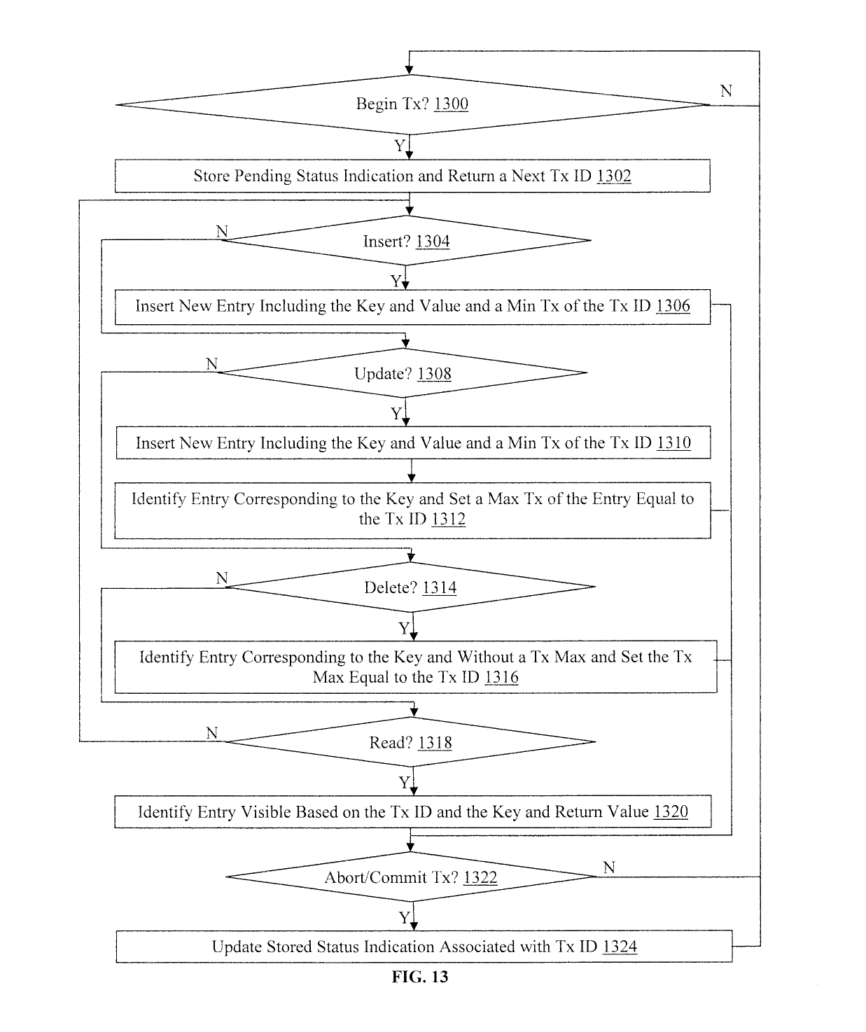

Optionally, the operation can be managed through transactions using the begin-transaction and transaction-commit operations illustrated in table 1000 and received by the system node computing device 21(3). Also optionally, transaction status can be retrieved via a transaction-status operation and transactions can be aborted via a transaction-abort operation, as illustrated in table 1000. The operation of transactions is described and illustrated in more detail later with reference to FIG. 13. Items can also be stored in other way in other examples. Accordingly, by storing the item in the silver zone 18(3) in this particular example, the item will be stored according to the SLCs shared by the group 20(5)-20(7) of the silver zone 18(3).

Referring back to FIG. 5, subsequent to storing an item in step 512, or if the system node computing device 21(3) determines in step 510 that a request to put an item has not been received and the No branch is taken, the system node computing device 21(3) proceeds to step 514. In step 514, the one system node computing device 21(3) determines whether a request has been received from one of the application(s) 32, as optionally generated using the SDK 34 and via the REST API, to get an item from a database, such as the database created in step 508.

If the system node computing device 21(3) determines that a request to get an item has not been received, then the No branch is taken back to step 500, although the system node computing device 21(3) could also proceed back to step 510 in other examples. Optionally, one or more of the steps 502-508 can also be repeated in order to expand the data storage network 14 and/or the databases or portions thereof that are stored therein. Also optionally, the system node computing device 21(3) can receive a snapshot request at any time subsequent to creation of the storage elements in step 508, as described and illustrated in more detail later with reference to FIG. 12.

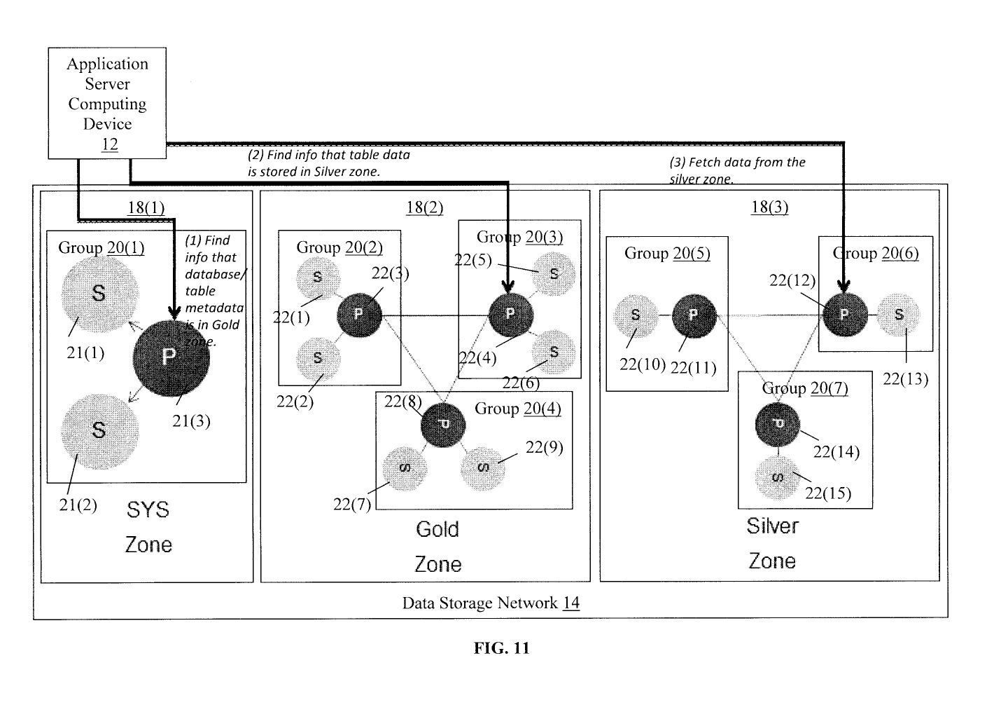

However, if the system node computing device 21(3) determines in step 514 that a request to get an item has been received, then the Yes branch is taken to step 516. In step 516, the system node computing device 21(3) determines where the item is stored. Referring more specifically to FIG. 11, a functional flow diagram illustrating an exemplary method for retrieving an item previously stored in the data storage network 14 is illustrated. Referring back to FIG. 10B, the item-get operation request includes a table name, root table name, entity group key, row key, and a transaction identifier.

Accordingly, in a first step in the example illustrated in FIG. 11, the item-get operation request is received by the system node computing device 21(3) from one of the application server computing devices 12(1)-12(n) and includes an indication of the table (e.g., “{TableName}”), which is used by the system node computing device 21(3) to identify a specified one of the zones 18(2) or 18(3) for the table in which the item is stored. In this particular example, the system node computing device 21(3) determines from the tables one of the system tables 46 that the metadata for the table is stored in the gold zone 18(3), which is communicated back to the one of the application server computing devices 12(1)-12(n).

In response and in a second step, the one of the application server computing devices 12(1)-12(n) communicates with the primary storage node computing device 22(4) of the gold zone 18(2), which determines that the table data (e.g., the items) is stored in the silver zone 18(3) and communicates this information back to the one of the application server computing devices 12(1)-12(n). In response and in a third step, the one of the application server computing devices 12(1)-12(n) communicates with the primary storage node computing device 22(12) of the silver zone 18(3), which provides the requested item as identified based on the key information included in the item-get operation request and communicated to the storage node computing device 22(12), for example.

Referring more specifically to FIG. 12 a table 1200 illustrating an exemplary portion of the REST API 36 that can be used to perform snapshot operations or transactions is illustrated. In this example, the operations include snapshot-create and snapshot-restore, although other snapshot operations can also be used in other examples. Accordingly, the one of the application server computing devices 12(1)-12(n) or an administrator computing device can use the snapshot-create operation to generate a snapshot of the items stored in an entity group of a database, for example, to establish a point-in-time view of the items stored therein. The system node computing device 21(3) can create the snapshot and store it as associated with a unique snapshot identifier. The system node computing device 21(3) can then restore an entity group, for example, based on the stored snapshot in response to a receive request to restore a snapshot that includes the unique snapshot identifier. Snapshot transaction are described and illustrated in more detail later with reference to steps 14 and 15.

Referring more specifically to FIG. 13, a flowchart of an exemplary method for processing transactions by the one of the exemplary system node computing devices is illustrated. By using transactions to encapsulate operations as described and illustrated herein, snapshots can be more effectively captured to guarantee a consistent point-in-time image of an entity-group in a database from which data can be restored in the event of a loss.

In step 1300 in this particular example, the system node computing device 21(3) determines whether a request to begin a transaction has been received. The request can be sent by one of the applications 32 hosted by one of the application server computing devices 14(1)-14(n) or an administrator computing device using the begin-transaction API call illustrated in table 1000, for example, although other methods of initiating a transaction can also be used. If the system node computing device 21(3) determines a request to begin a transaction has not been received, then the No branch is taken back to step 1300 and the system node computing device 21(3) effectively waits for a transaction begin request to be received. However, if the system node computing device 21(3) determines a request to begin a transaction has been received, then the Yes branch is taken to step 1302.

In step 1302, the system node computing device 21(3) generates a transaction identifier (also referred to herein as Tx ID) and stores a pending status indication associated with the transaction identifier in the memory 40. The status in this example can be retrieved by any other transaction, such as using the transaction-status API call illustrated in table 1000, as described and illustrated in more detail later. In this example, transaction identifiers are generated atomically, but transaction identifiers can be generated in other ways in other examples. Additionally, in step 1302, the system node computing device 21(3) returns the transaction identifier in response to the transaction begin request.

In step 1304, the system node computing device 21(3) determines whether a request (also referred to herein as a command) to insert an item has been received, such as from one of the applications 32 and via the item-put API call illustrated in table 1000. Insert commands in this example include at least an attribute key/value pair and a transaction identifier, such as the transaction identifier generated and return in step 1302. If the system node computing device 23(1) determines an insert command is received, then the Yes branch is taken to step 1306.

In step 1306, the system node computing device 23(1) inserts a new entry (also referred to herein as a row) in a transaction one of the system tables 46. The new entry includes the key and value included in the insert command and a first or minimum transaction value (also referred to herein as Min Tx or xmin) equal to the transaction identifier included in the insert command, although the first transaction value could be a maximum value in examples in which the transaction identifiers are assigned in a descending order, for example. The minimum transaction value indicates the earlier transaction for which the item is valid or visible, which in the example is the transaction associated with the item insert request. In one example, transaction 10 (TX-10) inserts a new item to the transaction one of the system tables 46 with the key “123” and the value “A”. The row in the transaction one of the system tables 46 will appear as illustrated below in Table 1 subsequent to step 1306:

TABLE 1

| xmin | x max | cmin | cmax | key | value |
|---|---|---|---|---|---|
| 10 | 0 | 1 | 0 | 123 | A |

In this example, TX-10 creates this item, so xmin is 10. Currently, the item is valid, so the second or maximum transaction value (also referred to herein as Max Tx or xmax) is “0” indicating that it is not assigned to a transaction and that the item has not been updated yet, as described and illustrated in more detail later, although the second transaction value could be a minimum value in examples in which the transaction identifiers are assigned in a descending order, for example, and other values and the absence of a transaction maximum value can also be used to indicate that an item has not been updated.

In examples in which a plurality of commands are associated with one transaction, the minimum command value (also referred to herein as cmin) and maximum command value (also referred to herein as cmax) are used in a corresponding manner as described and illustrated herein with reference to the minimum transaction value and maximum transaction value used in the context of multiple transactions. Additionally, in these examples, an entry is visible for a command if inserted before the command and not deleted yet, or deleted by another command not before the command.

Referring back to step 1304, if the system node computing device 21(3) determines that an insert command has not been received, then the No branch is taken to step 1308. In step 1308, the system node computing device 21(3) determines whether a request to update an item has been received, such as from one of the applications 32. In this example, the item update request includes at least an attribute key/value pair and a transaction identifier. Accordingly, the update request is initiated in order to replace a stored value associated with the provided key, with a new value included with the request. If the system node computing device 21(3) determines that a request to update an item has been received, then the Yes branch is taken to step 1310.

In step 1310, the system node computing device 21(3) inserts a new entry into the transaction one of the system tables 46. The new entry includes the key and value included in the item update request and a minimum transaction value equal to the transaction identifier included in the item update request, which can be the transaction identifier generated and returned in step 1302, for example.

In step 1312, the system node computing device 21(3) identifies an entry corresponding to the key included in the item update request and sets a maximum transaction value equal to the transaction identifier included in the item update request. The maximum transaction value in the identified entry is replaced with the transaction identifier associated with the item update request because the value in the identified entry will not be valid for the item after the transaction corresponding to the item update request commits, as described and illustrated in more detail later.

Referring to the example described and illustrated earlier with reference to Table 1, assuming TX-11 is an item update request to update the item inserted in TX-10 with the value “B”, then the rows in the transaction one of the system tables 46 appear as illustrated below in Table 2 subsequent to step 1312 (and TX-11 committing):

TABLE 2

| xmin | xmax | cmin | cmax | key | value |
|---|---|---|---|---|---|
| 10 | 11 | 1 | 0 | 123 | A |
| 11 | 0 | 1 | 0 | 123 | B |

Referring back to step 1308, if the system node computing device 21(3) determines that an item update command has not been received, then the No branch is taken to step 1314. In step 1314, the system node computing device 21(3) determines whether a request to delete an item has been received, such as from one of the applications 32. In this example, the item delete request includes at least an attribute key and a transaction identifier. Accordingly, the update request is initiated in order to delete an item associated with the provided key. If the system node computing device 21(3) determines that a request to delete an item has been received, then the Yes branch is taken to step 1316.

In step 1316, the system node computing device 21(3) identifies an entry of the transaction one of the system tables 46 that corresponds to the key included in the item delete request and that does not have a maximum transaction value (or has a transaction maximum value of “0” in the examples described and illustrated herein). An entry corresponding to the key and without a maximum transaction value will be a currently visible entry for the item associated with the key.

Accordingly, the system node computing device 21(3) also sets the maximum transaction value of the identified entry equal to the transaction identifier included in the item delete request to indicate that the item is only visible for transactions having an associated transaction identifier less than the transaction identifier of the transaction that deleted the item. Referring to the example described and illustrated earlier with reference to Table 1-2, assuming TX-12 is an item delete request to delete the item inserted in TX-10 and updated in TX-11, then the rows in the transaction one of the system tables 46 appear as illustrated below in Table 3 subsequent to step 1316 (and TX-12 committing):

TABLE 3

| xmin | xmax | cmin | cmax | key | value |
|---|---|---|---|---|---|
| 10 | 11 | 1 | 0 | 123 | A |
| 11 | 12 | 1 | 0 | 123 | B |

In this example, item value “B” expires after TX-12 is committed, and the item with key “123” does not exist any more, but the two out-of-date versions, “A” and “B” are still maintained in the transaction one of the system tables 46. Referring back to step 1314, if the system node computing device 21(3) determines that an item delete command has not been received, then the No branch is taken to step 1318. In step 1318, the system node computing device 21(3) determines whether a request to read an item has been received, such as from one of the applications 32 via the item-get API call described and illustrated earlier with reference to table 1000.

In this example, the item read request includes at least an attribute key and a transaction identifier. Accordingly, the read request is initiated in order to read an item associated with the provided key. If the system node computing device 21(3) determines that a request to read an item has been received, then the Yes branch is taken to step 1320. In step 1320, the system node computing device 21(3) identifies an entry in the transaction one of the system tables 46 that is visible based on the transaction identifier and the key included in the item read request. Accordingly, the system node computing device 21(3) identifies the entries in the transaction one of the system tables 46 that has a key matching the key included in the item read request.

Next, the system node computing device 21(3) determines the one of the entries that is currently visible for the transaction associated with the item read request and returns the value of the visible entry in response to the item read request. For an entry to be visible, the item must be inserted by a committed transaction. Accordingly, if the inserting transaction associated with an entry is still in process or it is aborted, then the entry is not visible. However, if the item associated with an entry is not deleted, is not deleted successfully (e.g., the deleting transaction aborts), or is not deleted yet (e.g., by a non-committed transaction), it is visible.

### Example 1

### Concurrent Read and Write Transactions

In this example, TX-5 inserted item (123, A) and successfully committed. Later, there are two concurrent transactions 10 and 11 in progress and executing concurrently. TX-10 reads the data and TX-11 tries to update it to (123, B). Before transactions 10 and 11 start, the rows of the transaction one of the system tables 46 in this example appear as illustrated below in Table 4, when TX-11 updates, the rows will appear as illustrated below in Table 5 in a first step and in Table 6 in a second step:

TABLE 4

| xmin | xmax | cmin | cmax | key | value |
|---|---|---|---|---|---|
| 5 | 0 | 1 | 0 | 123 | A |

TABLE 5

| xmin | xmax | cmin | cmax | key | value |
|---|---|---|---|---|---|
| 5 | 0 | 1 | 0 | 123 | A |
| 11 | 0 | 1 | 0 | 123 | B |

TABLE 6

| xmin | xmax | cmin | cmax | key | value |
|---|---|---|---|---|---|
| 5 | 11 | 1 | 0 | 123 | A |
| 11 | 0 | 1 | 0 | 123 | B |

In this example, TX-10 can read the item associated with key 123 at three different times. If TX-10 reads before TX-11 makes any update, the row (123, A) will be visible to TX-10. If TX-10 reads after step 1 illustrated above in Table 5, there are two versions. The second version is inserted by a not-yet-committed transaction in this example, thus only (123, A) is visible to TX-10. If TX-10 reads after step 2 illustrated above in Table 6, the first version is updated by a not-yet-committed transaction, and thus is still visible to TX-10. Therefore, irrespective of how the execution proceeds, TX-10 always sees the same version, and therefore consistency is always advantageously guaranteed.

### Example 2

### Aborted Transactions

In this example, TX-5 inserted (123, A) and committed successfully. TX-10 tries to update it to (123, B). However, TX-10 aborts prior to being committed. Later, TX-20 tries to read the data. Accordingly, in this example, after TX-5 commits, the rows in the transaction one of the system tables 46 appear as illustrated in Table 7 below. Additionally, although TX-10 aborts, it updates the transaction one of the system tables 46 as illustrated below in Table 8.

TABLE 7

| xmin | xmax | cmin | cmax | key | value |
|---|---|---|---|---|---|
| 5 | 0 | 1 | 0 | 123 | A |

Accordingly, when TX-20 attempts to read the item associated with key 123, xmax of version 1 is a not-committed transaction, while xmin of version 2 is also a not-committed transaction. Therefore, only version 1 is visible to TX-20 (and item value “A” will be returned).

Referring back to FIG. 13, subsequent to returning the value of a visible entry of the transaction one of the system tables 46 for the key included in the item read request in step 1320, or if the system node computing device 21(3) inserts a new entry in step 1306, updates an entry in step 1312, or deletes an entry in step 1316, the system node computing device 21(3) proceeds to step 1322.

In step 1322, the system node computing device 21(3) receives a request to abort or commit a transaction, such as the transaction associated with the begin transaction request received in step 1300. In this example, the request to abort or commit a transaction includes at least a transaction identifier and can be sent by one of the application(s) 32 via the transaction-abort and transaction-commit API calls illustrated in table 1000, for example. If the system node computing device 21(3) determines in step 1322 that a request to abort or commit a transaction has been received, then the Yes branch is taken to step 1324.

In step 1324, the system node computing device 21(3) updates a stored status indication associated with the transaction identifier included in the received request to indicate that the transaction is aborted or committed according to the type of the received request. The status indication could have been previously stored in the memory 40 as described and illustrated earlier with reference to step 1302, for example. Subsequent to updating the stored status, or if the system node computing device 21(3) determines in step 1322 that a request to abort or commit a transaction has not been received and the No branch is taken, the system node computing device 21(3) proceeds back to step 1300 and waits to receive another begin request for another transaction.

Referring back to step 1318, if the system node computing device 21(3) determines that an item read command has not been received, then the No branch is taken and the system node computing device 21(3) proceeds back to step 1304 and the system node computing device 21(3) effectively waits for a command associated with the transaction begin in step 1300 to be received. Accordingly, in the examples described and illustrated herein, each transaction encapsulates one command, although the transactions can encapsulate any number of commands in other examples, as described and illustrated in more detail earlier.

Additionally, any of steps 1304-1320 can occur in parallel for any number of commands associated with a same transaction. Additionally, any of steps 1300-1324 can occur in parallel for any number of transactions. While insert, update, delete, and read commands are identified for purposes of the examples described and illustrated herein, other numbers and types of commands can also be used in other examples.

The examples described and illustrated herein for snapshot management leverage the transaction processing and associated transaction table management described and illustrated earlier with reference to FIG. 13. Accordingly, this technology advantageously provides both consistency and storage efficiency. This technology supports transactions inside one entity group. The entity group key is used to partition data. Rows in the transaction one of the system tables 46 that belong to the same entity group share the same entity group key, and will be located in the same zone 18(2) or 18(3). Accordingly, updates to one entity group can be synchronized among multiple replicas since the replication granularity is per entity group. With this technology, snapshots are taken at the entity group level and are treated as transactions in order to achieve consistency among the entity group. Optionally, administrators can store related information inside one entity group so that operations can be ACID.

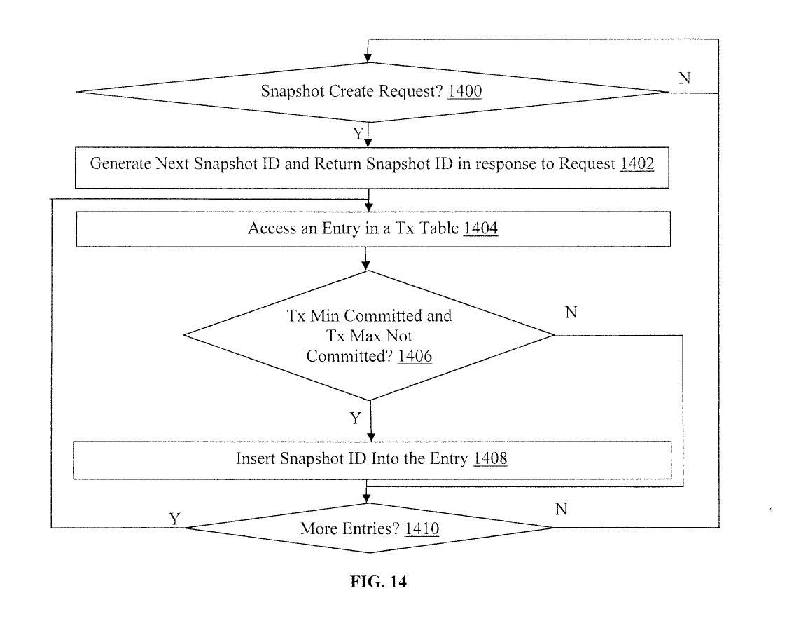

Referring more specifically to FIG. 14, a flowchart of an exemplary method for generating a snapshot is illustrated. In step 1400 in this example, the system node computing device 21(3) determines whether a request to create a snapshot request has been received. The request can be received from one of the application(s) hosted by the application server computing devices 12(1)-12(n) or an administrator computing device, for example, via the snapshot-create API call illustrated in Table 1200, although other sources of, or methods for receiving, a request to create a snapshot can also be used. If the system node computing device 21(3) determines that a snapshot create request has not been received, then the No branch is taken back to step 1400 and the system node computing device 21(3) effectively waits for a snapshot create request to be received. However, if the system node computing device 21(3) determines that a request to create a snapshot has been received, then the Yes branch is taken to step 1402.

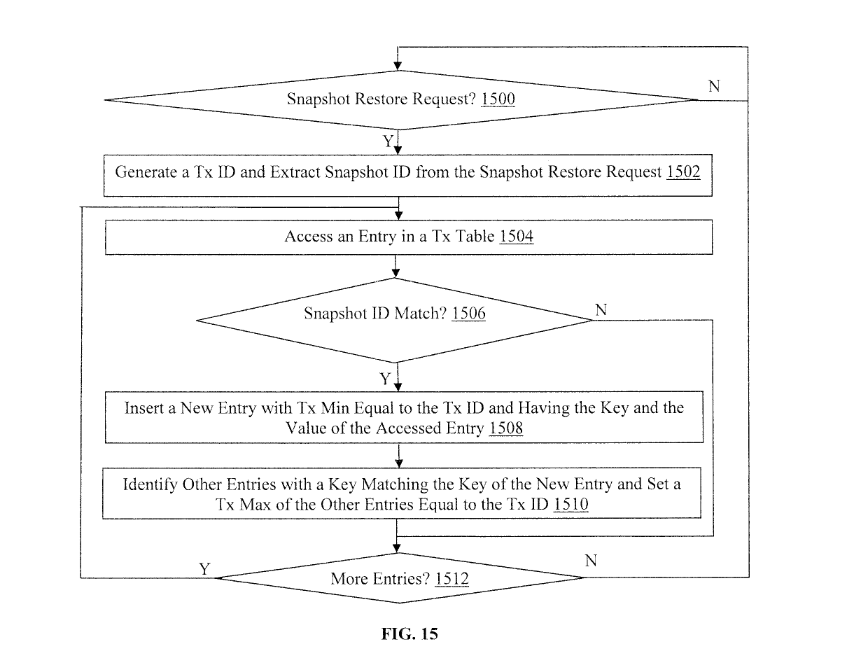

In step 1402, the system node computing device 21(3) generates a snapshot identifier (ID) and a transaction identifier and returns the snapshot identifier in response to the snapshot create request. In this example, the transaction identifier can be generated as described and illustrated earlier with reference to step 1302 of FIG. 13 and the snapshot identifier is an atomically next number following a previously generated snapshot identifier, but the snapshot identifier can be generated in other ways. The snapshot identifier is returned in response to the snapshot create request so that it can be subsequently used to identify the snapshot should the snapshot need to be restored, as described and illustrated in more detail later with reference to FIG. 15.

In step 1404, the system node computing device 21(3) retrieves an entry in the transaction one of the system tables 46. The retrieved entry can be located anywhere in the transaction one of the system tables 46 as a plurality of entries (e.g., all those associated with a particular entity group identified by an entity group key in the create snapshot request) will be accessed or parsed as part of the processing of the snapshot create request.

In step 1406, the system node computing device 21(3) determines whether the entry has a transaction minimum value corresponding to a transaction that has been committed and a transaction maximum value corresponding to a transaction that has not been committed. In this example, if the entry does not have a maximum transaction value (or has a value of “0”), then the entry does not have a transaction maximum value corresponding to a transaction that has not been committed. In order to determine whether the transaction has been committed, the system node computing device 21(3) can retrieve the status identifier from the memory 40, for example, which can be stored as described and illustrated earlier with reference to steps 1302 and 1324.

If the entry has a minimum transaction value corresponding to a transaction that has not been committed yet, then that transaction could still be aborted, and therefore is not visible to the snapshot. However, if the entry has a minimum transaction value corresponding to a transaction that has been committed but a transaction maximum value corresponding to a transaction that has not been committed, then the transaction not committed could still be aborted, and the entry is visible to the snapshot. Additionally, if the entry has a minimum transaction value corresponding to a transaction that has been committed but does not have a maximum transaction value (and therefore does not have a maximum transaction value corresponding to a transaction that has not been committed), then the entry has not expired and is visible to the snapshot.

Finally, if the entry has a minimum transaction value corresponding to a transaction that has been committed but has a maximum transaction value corresponding to a transaction that has been committed, then the entry has expired (e.g., been updated or deleted, as described and illustrated in more detail earlier with reference to steps 1312 and 1316, respectively), and therefore is not visible to the snapshot. Accordingly, if the system node computing device 21(3) determines that the entry has a transaction minimum value corresponding to a transaction that has been committed and a transaction maximum value corresponding to a transaction that has not been committed, then the Yes branch is taken to step 1408.

In step 1408, the system node computing device 21(3) inserts the snapshot identifier generated in step 1402 into the entry accessed in step 1404. The snapshot identifier is inserted into the entry because the entry is visible to the snapshot at the point in time corresponding to the snapshot create request, and can be used to restore based on the snapshot in the event of a loss, for example, as described and illustrated in more detail later with reference to FIG. 15.

Subsequent to inserting the snapshot identifier in step 1408, or if the system node computing device 21(3) determines in step 1406 that the entry does not have a transaction minimum value corresponding to a transaction that has committed and a transaction maximum value corresponding to a transaction that has not been committed, and the No branch is taken, then the system node computing device 21(3) proceeds to step 1410. In step 1410, the system node computing device 21(3) determines whether there are additional entries (e.g., corresponding to the entity group key included in the snapshot create request) in the transaction one of the system tables 46 that have not been accessed.

If the system node computing device 21(3) determines that there is at least one additional entry, then the Yes branch is taken back to step 1404 and the additional entry is accessed as described and illustrated earlier. However, if the system node determines in step 1410 that there are no additional entries, then the No branch is taken back to step 1400 and the system node computing device 21(3) waits to receive another snapshot create request.

Tables 9-12 set forth below illustrate an exemplary processing of two snapshot create requests. In Table 9 in this example, the transaction one of the system tables 46 is shown after a first snapshot having a transaction identifier of “20” and a snapshot identifier of “1” is received and processed.

TABLE 9

| Snapshots | xmin | xmax | cmin | cmax | key | value |
|---|---|---|---|---|---|---|
| 1 | 5 | 0 | 1 | 0 | 123 | A |
| 1 | 10 | 0 | 1 | 0 | 456 | B |

In Table 10 in this example, the exemplary transaction one of the system tables 46 is shown after an update command having associated transaction identifier “30” has been received to update key “456” to value “B2”. In this example, the snapshot identifier “1” is inserted into the first entry because the minimum transaction value of this entry corresponds with a committed transaction and the entry does not include a maximum transaction value (the maximum transaction value is “0” in this example indicating an absence of a maximum transaction). Additionally, the snapshot identifier “1” is inserted into the second entry because the maximum transaction value corresponds to a transaction that has not yet been committed.

TABLE 10

| Snapshots | xmin | xmax | cmin | cmax | key | value |
|---|---|---|---|---|---|---|
| 1 | 5 | 0 | 1 | 0 | 123 | A |
| 1 | 10 | 30 | 1 | 0 | 456 | B |
| | 30 | 0 | 1 | 0 | 456 | B2 |

In Table 11, the exemplary transaction one of the system tables 46 is shown after an update command having a transaction identifier of “50” has been received to update key “123” to value “A2”, but has not committed, and after a second snapshot having a transaction identifier of “51” and a snapshot identifier of “2” is received, but not yet processed.

TABLE 11

| Snapshots | xmin | xmax | cmin | cmax | key | value |
|---|---|---|---|---|---|---|
| 1 | 5 | 50 | 1 | 0 | 123 | A |
| 1 | 10 | 30 | 1 | 0 | 456 | B |
| | 30 | 0 | 1 | 0 | 456 | B2 |
| | 50 | 0 | 1 | 0 | 123 | A2 |

Table 12 illustrates the exemplary transaction one of the system tables 46 after the second snapshot having a transaction identifier of “51” and a snapshot identifier of “2” is processed. In this example, the snapshot identifier “2” is inserted into the first entry because the transaction corresponding to the minimum transaction value “5” has been committed but the transaction corresponding to the maximum transaction value “50” has not been committed yet, and the entry is therefore visible to the second snapshot. The snapshot identifier “2” is not inserted into the second entry because the second entry has a maximum transaction value that corresponds with a transaction that has been committed.

The snapshot identifier “2” is inserted into the third entry in this example because the third entry has a minimum transaction value that corresponds with a transaction that has been committed but does not have any maximum transaction value (and therefore does not have a maximum transaction value corresponding to a transaction that has not been committed), and is therefore visible to the snapshot. Finally, the snapshot identifier “2” is not inserted into the fourth entry because the fourth entry does not have a transaction minimum value corresponding to a transaction that has been committed, and the fourth entry therefore is not visible to the second snapshot.

TABLE 12

| Snapshots | xmin | xmax | cmin | cmax | key | value |
|---|---|---|---|---|---|---|
| 1, 2 | 5 | 50 | 1 | 0 | 123 | A |
| 1 | 10 | 30 | 1 | 0 | 456 | B |
| 2 | 30 | 0 | 1 | 0 | 456 | B2 |
| | 50 | 0 | 1 | 0 | 123 | A2 |

Referring more specifically to FIG. 15, a flowchart of an exemplary method for restoring a database from a snapshot is illustrated. In step 1500 in this example, the system node computing device 21(3) determines whether a request to restore a snapshot request has been received. The request can be received from one of the application(s) hosted by the application server computing devices 12(1)-12(n) or an administrator computing device, for example, via the snapshot-restore API call illustrated in Table 1200, although other sources of, or methods for receiving, a request to restore a snapshot can also be used. In this example, the snapshot restore request includes at least a snapshot identifier of the snapshot to be restored, such as the snapshot identifier returns as described and illustrated in more detail earlier with reference to step 1402 of FIG. 14.

If the system node computing device 21(3) determines that a snapshot restore request has not been received, then the No branch is taken back to step 1500 and the system node computing device 21(3) effectively waits for a snapshot restore request to be received. However, if the system node computing device 21(3) determines that a request to restore a snapshot has been received, then the Yes branch is taken to step 1502.

In step 1502, the system node computing device 21(3) generates a transaction identifier and extracts the snapshot identifier from the snapshot restore request. The transaction identifier can be a next transaction identifier, as described and illustrated earlier. In step 1504, the system node computing device 23(1) retrieves or accesses an entry in the transaction one of the system tables 46. The accessed entry can be located anywhere in the transaction one of the system tables 46.

In step 1506, the system node computing device 23(1) determines whether a snapshot identifier of the accessed entry matches the snapshot identifier included in the snapshot restore request. The entry having a matching snapshot identifier will also include the item value that should be restored. If the system node computing device 23(1) determines that the snapshot identifier match, then the Yes branch is taken to step 1508.

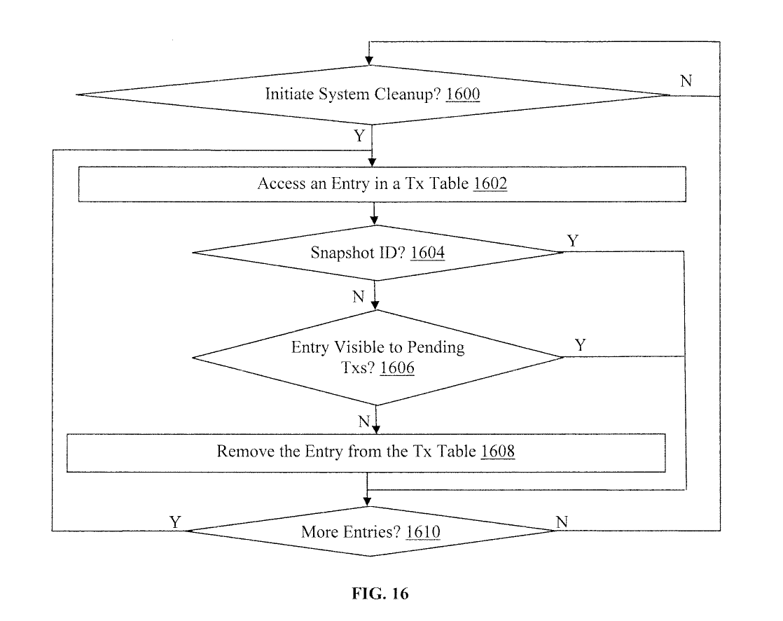

In step 1508, the system node computing device 23(1) inserts a new entry into the transaction one of the system tables 46. The new entry includes a minimum transaction value equal to the transaction identifier generated in step 1502, and has a key and item value of the retrieved entry. Accordingly, the new entry is visible beginning with the transaction corresponding to the snapshot restore request, but the access entry is maintained until recycled in a system cleanup process described and illustrated in more detail later with reference to FIG. 16.

In step 1510, the system node computing device 23(1) identifies all other entries that have a key matching the key of the new entry (and of the retrieved entry) and sets a maximum transaction value of all of the other entries equal to the transaction identifier generated in step 1502. Accordingly, all of the other entries corresponding to the key will not be visible to transactions having an identifier after the transaction identifier of the system restore since those entries are expired and have an item value that is no longer valid subsequent to the snapshot restore.

Subsequent to identifying the other entries and marking the entries as expired, or if the system node computing device 21(3) determines in step 1506 that the snapshot identifier of the accessed entry does not match the snapshot identifier of the snapshot restore request and the No branch is taken, then the system node computing device 21(3) proceeds to step 1512. In step 1512, the system node computing device 21(3) determines whether there are additional entries in the transaction one of the system tables 46 that have not been accessed.

If the system node computing device 21(3) determines that there is at least one additional entry, then the Yes branch is taken back to step 1504 and the additional entry is accessed as described and illustrated earlier. However, if the system node computing device 21(3) determines in step 1512 that there are no additional entries, then the No branch is taken back to step 1500 and the system node computing device 21(3) waits to receive another snapshot restore request.

Tables 13-14 set forth below illustrate an exemplary processing of a snapshot restore request based on the example described and illustrated earlier with reference to Tables 9-12. Table 13 in this example corresponds to Table 12 illustrated earlier except that all of the identifier transaction identifiers correspond to committed transactions.

TABLE 13

| Snapshots | xmin | xmax | cmin | cmax | key | value |
|---|---|---|---|---|---|---|
| 1, 2 | 5 | 50 | 1 | 0 | 123 | A |
| 1 | 10 | 30 | 1 | 0 | 456 | B |
| 2 | 30 | 0 | 1 | 0 | 456 | B2 |
| | 50 | 0 | 1 | 0 | 123 | A2 |

Tables 14 reflects this exemplary transaction one of the system tables 46 subsequent to a snapshot restore request having an associated transaction identifier of “100” and including a snapshot identifier of “1”. Accordingly, in this example, the first and second entries have a matching snapshot identifier of “1” and therefore include the item values for their respective keys that should be visible subsequent to the snapshot restore transaction. Therefore, the fifth and sixth entries are added as new entries to the transaction one of the system tables 46 with a transaction minimum value equal to the transaction identifier “100” of the snapshot restore and having the key “123” and “456” and value “A” and “B” of the accessed first and second entries, respectively.

Additionally, the third and fourth entries have keys matching the keys of the new entries, and therefore the maximum transaction value of the third and fourth entries has been set equal to the transaction identifier of the snapshot restore transaction. Therefore, these entries will not longer be visible to transaction having a transaction identifier great than “100” after the snapshot restore transaction has been committed.

TABLE 14

| Snapshots | xmin | xmax | cmin | cmax | key | value |
|---|---|---|---|---|---|---|
| 1, 2 | 5 | 50 | 1 | 0 | 123 | A |
| 1 | 10 | 30 | 1 | 0 | 456 | B |
| 2 | 30 | 100 | 1 | 0 | 456 | B2 |
| | 50 | 100 | 1 | 0 | 123 | A2 |
| | 100 | 0 | 1 | 0 | 123 | A |
| | 100 | 0 | 1 | 0 | 456 | B |

Accordingly, in this example any transaction after the snapshot restore transaction having associated transaction identifier “100” has been committed will see the old value from snapshot “1”. The item value “B2” corresponding to the key “456”, which is captured by snapshot having snapshot identifier “2”, will remain in the transaction one of the system tables 46. Therefore, if a snapshot restore request is subsequently received including snapshot identifier “2”, the item value “B2” will then be visible for the key “456”. Accordingly, with this technology, a snapshot restore can advantageously be implemented without significant additional data management overhead.

Referring more specifically to FIG. 16, a flowchart of an exemplary method for implementing a system cleanup to recycle unnecessary portions of the transaction one of the system tables 46 for storage efficiency purposes is illustrated. In step 1600 in this example, the system node computing device 21(3) determines whether a system cleanup has been initiated. A system cleanup can be initiated manually, such as by an administrator interfacing with the system node computing device 21(3) via an administrator computing device.

Alternatively, the system node computing device 21(3) can be configured to periodically initiate a system cleanup, and other methods for initiating a system cleanup can also be used. If the system node computing device 21(3) determines that a system cleanup has not been initiated, then the No branch is taken back to step 1600 and the system node computing device effectively waits for a system cleanup to be initiated. However, if the system node computing device 21(3) determines that a system cleanup has been initiated, then the Yes branch is taken to step 1602.

In step 1602, the system node computing device 23(1) retrieves or accesses an entry in the transaction one of the system tables 46. The accessed entry can be located anywhere in the transaction one of the system tables 46. In step 1604, the system node computing device 21(3) determines whether the entry includes a snapshot identifier. If the accessed entry includes a snapshot identifier, it will not be removed or recycled (until the snapshot is deleted) since a subsequent snapshot restore request could be received that includes the snapshot identifier. Accordingly, if the system node computing device 21(3) determines in step 1604 that the entry does not include a snapshot identifier, then the No branch is taken to step 1606.

In step 1606, the system node computing device 21(3) determines whether the entry is visible to any pending transactions. In one example, an entry is not visible to any pending transaction if it includes transaction minimum and maximum values that correspond to transactions that have been committed, and no transaction corresponding with a transaction identifier between the minimum and maximum transaction values are pending (e.g., as determined based on the stored status indicator as described and illustrated in more detail earlier).

In another example, entries that were inserted by transactions that were aborted prior to being committed are not visible to any pending transactions. Such entries can be identified based on a minimum transaction value corresponding to a transaction having an aborted status, as identified based on a stored status indicator as described and illustrated in more detail earlier. In yet another example, entries that are older versions of newer entries created by an item update command will not be visible to any pending transactions assuming no transactions having a transaction identifier less than the maximum transaction value are pending. Other types and numbers of entries can also be not visible to any pending transactions in other examples.

Accordingly, if the system node computing device 21(3) determines that the entry is not visible to any pending transactions, then the No branch is taken to step 1608. In step 1608, the system node computing device 21(3) removes the entry from the transaction one of the system tables 46. In some examples the content of the entry is removed and in other examples the entry can be marked as recyclable, and other methods of removing the entry can also be used in yet other examples. Subsequent to removing the entry, or if the system node computing device 21(3) determines that the entry has a snapshot identifier in step 1604 and the Yes branch is taken, or is visible to at least one pending transaction in step 1606 and the Yes branch is taken, the system node computing device 21(3) proceeds to step 1610.

In step 1610, the system node computing device 21(3) determines whether there are additional entries in the transaction one of the system tables 46 that have not been accessed during the current system cleanup iteration. If the system node computing device 21(3) determines that there is at least one additional entry, then the Yes branch is taken back to step 1602 and the additional entry is accessed as described and illustrated earlier. However, if the system node computing device 21(3) determines in step 1610 that there are no additional entries, then the No branch is taken back to step 1600 and the system node computing device 21(3) waits for another system cleanup to be initiated.

Accordingly, with this technology, application administrators can more effectively leverage NoSQL databases by storing data in tables located on storage node computing devices in groups and zones that have associated SLCs, as previously established upon creation of the tables or an associated entity group or database. Accordingly, management of the data is relatively integrated and policies do not have to be analyzed for every ingested item in order to provide appropriate data tiering for the data storage network. By more efficiently implementing data tiering for NoSQL databases, data can be aged more effectively. Additionally, this technology is highly scalable as capacity having predictable and established service levels can be added dynamically.

Moreover, this technology advantageously facilitates more efficient creation and management of snapshots and the restoration of data using snapshots. With this technology, management resources required to implement snapshots of a NoSQL database are reduced. In particular, this technology generates and maintains snapshots by modifying rows in a transaction table to include certain markers, and without making extra copies of existing data. Advantageously, snapshot operation and management is relatively lightweight and storage efficient with this technology.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for implementing NoSQL database snapshots, the method comprising:
generating, by a system node computing device, a snapshot identifier and returning the snapshot identifier in response to a received request to create a snapshot of a NoSQL database;
determining, by the system node computing device, when an entry in a transaction table has a first transaction value corresponding to a transaction that has been committed and a second transaction value that is not assigned or corresponds to another transaction that has not been committed;
inserting, by the system node computing device, the snapshot identifier into the entry when the entry is determined to have the first transaction value corresponding to the transaction that has been committed and the second transaction value that is not assigned or corresponds to the another transaction that has not been committed.

2. The method as set forth in claim 1, further comprising:
generating, by the system node computing device, a transaction identifier in response to, and extracting the snapshot identifier from, a received snapshot restore request; and
determining, by the system node computing device, when the entry has another snapshot identifier matching the snapshot identifier, and when the another snapshot identifier of the entry is determined to match the snapshot identifier:
inserting a new entry in the transaction table, the new entry comprising a third transaction value equal to the transaction identifier and a key and an item value of the entry; and
determining when another entry has another key matching the key and setting a fourth transaction value of the another entry equal to the transaction identifier, when the another entry is determined to have the another key matching the key.

3. The method as set forth in claim 1, further comprising inserting, by the system node computing device, a new entry in the transaction table, the new entry comprising a key and an item value, and setting a third transaction value of the new entry equal to a transaction identifier, in response to a received item insert request comprising the transaction identifier, the key, and the item value.

4. The method as set forth in claim 1, further comprising inserting, by the system node computing device, a new entry in the transaction table, the new entry comprising a key and an item value, setting a third transaction value of the new entry equal to a transaction identifier, identifying another entry that corresponds to the key, and setting a fourth transaction value of the another entry equal to the transaction identifier, in response to a received item update request comprising the transaction identifier, the key, and the item value.

5. The method as set forth in claim 1, further comprising identifying, by the system node computing device, another entry, the another entry corresponding to a key and that does not comprise a third transaction value, and inserting the transaction identifier as the third transaction value in the another entry, in response to a received item delete request comprising the transaction identifier and the key.

6. The method as set forth in claim 1, further comprising, in response to a received item read request comprising a key and a transaction identifier:
identifying, by the system node computing device, another entry comprising a third transaction value that is between the transaction identifier and a fourth transaction value that is not assigned or corresponds to an additional transaction that has not been committed; and
returning, by the system node computing device, an item value included in the another entry in response to the received item read request.

7. The method as set forth in claim 1, further comprising:
determining, by the system node computing device, when the entry includes a snapshot identifier and, when the entry is determined not to include the snapshot identifier, when the entry is not currently visible; and
removing, by the system node computing device, the entry from the transaction table when the entry is determined not to be currently visible.

8. A non-transitory computer readable medium having stored thereon instructions for implementing NoSQL database snapshots comprising executable code which when executed by a processor, causes the processor to perform steps comprising:
generating a snapshot identifier and returning the snapshot identifier in response to a received request to create a snapshot of a NoSQL database;
determining when an entry in a transaction table has a first transaction value corresponding to a transaction that has been committed and a second transaction value that is not assigned or corresponds to another transaction that has not been committed; and
inserting the snapshot identifier into the entry when the entry is determined to have the first transaction value corresponding to the transaction that has been committed and the second transaction value that is not assigned or corresponds to the another transaction that has not been committed.

9. The non-transitory computer readable medium as set forth in claim 8, further having stored thereon at least one additional instruction comprising executable code which when executed by a processor, causes the processor to perform at least one additional step comprising:
generating a transaction identifier in response to, and extracting the snapshot identifier from, a received snapshot restore request; and
determining when the entry has another snapshot identifier matching the snapshot identifier, and when the another snapshot identifier of the entry is determined to match the snapshot identifier:
inserting a new entry in the transaction table, the new entry comprising a third transaction value equal to the transaction identifier and a key and an item value of the entry; and
determining when another entry has another key matching the key and setting a fourth transaction value of the another entry equal to the transaction identifier, when the another entry is determined to have the another key matching the key.

10. The non-transitory computer readable medium as set forth in claim 8, further having stored thereon at least one additional instruction comprising executable code which when executed by a processor, causes the processor to perform at least one additional step comprising inserting a new entry in the transaction table, the new entry comprising a key and an item value, and setting a third transaction value of the new entry equal to a transaction identifier, in response to a received item insert request comprising the transaction identifier, the key, and the item value.

11. The non-transitory computer readable medium as set forth in claim 8, further having stored thereon at least one additional instruction comprising executable code which when executed by a processor, causes the processor to perform at least one additional step comprising inserting a new entry in the transaction table, the new entry comprising a key and an item value, setting a third transaction value of the new entry equal to a transaction identifier, identifying another entry that corresponds to the key, and setting a fourth transaction value of the another entry equal to the transaction identifier, in response to a received item update request comprising the transaction identifier, the key, and the item value.

12. The non-transitory computer readable medium as set forth in claim 8, further having stored thereon at least one additional instruction comprising executable code which when executed by a processor, causes the processor to perform at least one additional step comprising identifying another entry, the another entry corresponding to a key and that does not comprise a third transaction value, and inserting the transaction identifier as the third transaction value in the another entry, in response to a received item delete request comprising the transaction identifier and the key.

13. The non-transitory computer readable medium as set forth in claim 8, further having stored thereon at least one additional instruction comprising executable code which when executed by a processor, causes the processor to perform at least one additional step comprising, in response to a received item read request comprising a key and a transaction identifier:
identifying another entry comprising a third transaction value that is between the transaction identifier and a fourth transaction value is not assigned or corresponds to an additional transaction that has not been committed; and
returning an item value included in the another entry in response to the received item read request.

14. The non-transitory computer readable medium as set forth in claim 8, further having stored thereon at least one additional instruction comprising executable code which when executed by a processor, causes the processor to perform at least one additional step comprising:
determining when the entry includes a snapshot identifier and, when the entry is determined not to include the snapshot identifier, when the entry is not currently visible; and
removing the entry from the transaction table when the entry is determined not to be currently visible.

15. A system node computing device, comprising a processor and a memory coupled to the processor which is configured to be capable of executing programmed instructions comprising and stored in the memory to:
generate a snapshot identifier and return the snapshot identifier in response to a received request to create a snapshot of a NoSQL database;
determine when an entry in a transaction table has a first transaction value corresponding to a transaction that has been committed and a second transaction value that is not assigned or corresponds to another transaction that has not been committed; and
insert the snapshot identifier into the entry when the entry is determined to have the first transaction value corresponding to the transaction that has been committed and the second transaction value that is not assigned or corresponds to the another transaction that has not been committed.

16. The system node computing device as set forth in claim 15, wherein the processor is further configured to be capable of executing at least one additional programmed instruction comprising and stored in the memory to:
generate a transaction identifier in response to, and extracting the snapshot identifier from, a received snapshot restore request; and
determine when the entry has another snapshot identifier matching the snapshot identifier, and when the another snapshot identifier of the entry is determined to match the snapshot identifier:
insert a new entry in the transaction table, the new entry comprising a third transaction value equal to the transaction identifier and a key and an item value of the entry; and
determine when another entry has another key matching the key and setting a fourth transaction value of the another entry equal to the transaction identifier, when the another entry is determined to have the another key matching the key.

17. The system node computing device as set forth in claim 15, wherein the processor is further configured to be capable of executing at least one additional programmed instruction comprising and stored in the memory to insert a new entry in the transaction table, the new entry comprising a key and an item value, and setting a third transaction value of the new entry equal to a transaction identifier, in response to a received item insert request comprising the transaction identifier, the key, and the item value.

18. The system node computing device as set forth in claim 15, wherein the processor is further configured to be capable of executing at least one additional programmed instruction comprising and stored in the memory to insert a new entry in the transaction table, the new entry comprising a key and an item value, setting a third transaction value of the new entry equal to a transaction identifier, identifying another entry that corresponds to the key, and setting a fourth transaction value of the another entry equal to the transaction identifier, in response to a received item update request comprising the transaction identifier, the key, and the item value.

19. The system node computing device as set forth in claim 15, wherein the processor is further configured to be capable of executing at least one additional programmed instruction comprising and stored in the memory to identify another entry, the another entry corresponding to a key and that does not comprise a third transaction value, and inserting the transaction identifier as the third transaction value in the another entry, in response to a received item delete request comprising the transaction identifier and the key.

20. The system node computing device as set forth in claim 15, wherein the processor is further configured to be capable of executing at least one additional programmed instruction comprising and stored in the memory to, in response to a received item read request comprising a key and a transaction identifier:
identify another entry comprising a third transaction value that is between the transaction identifier and a fourth transaction value is not assigned or corresponds to an additional transaction that has not been committed; and
return an item value included in the another entry in response to the received item read request.

21. The system node computing device as set forth in claim 15, wherein the processor is further configured to be capable of executing at least one additional programmed instruction comprising and stored in the memory to:
determine when the entry includes a snapshot identifier and, when the entry is determined not to include the snapshot identifier, when the entry is not currently visible; and
remove the entry from the transaction table when the entry is determined not to be currently visible.
